(19) United States
(12) Patent Application Publication
(10) Pub. No.: US 2023/0109052 A1
(43) Pub. Date: Apr. 6, 2023

(54) TONER, TONER CARTRIDGE, AND IMAGE FORMING APPARATUS

(71) Applicant: TOSHIBA TEC KABUSHIKI KAISHA, Tokyo (JP)

(72) Inventor: Hiroshi Kawaguchi, Ashigarakami Kanagawa (JP)

(21) Appl. No.: 17/846,069

(22) Filed: Jun. 22, 2022

(30) Foreign Application Priority Data
Sep. 27, 2021 (JP) 2021-156537

(51) Int. Cl. G03G 9/097; G03G 9/08

(52) U.S. Cl. CPC G03G 9/09733; G03G 9/09725; G03G 9/0819; G03G 9/0808

(57) ABSTRACT

According to one embodiment, a toner contains a toner mother particle and an external additive. The toner mother particle contains a crystalline polyester resin and a specific ester wax. The external additive contains silica A having a D₅₀ of 10 nm to 14 nm and monodispersed silica B having a D₅₀ of 90 nm to 150 nm. The following conditions are satisfied. Content of silica A: 0.1 parts by mass to 0.8 parts by mass with respect to 100 parts by mass of the toner mother particle. Content of silica B: 0.3 parts by mass to 1.2 parts by mass with respect to 100 parts by mass of the toner mother particle. Ratio (content of silica B/content of silica A): 1.0 to 5.0. Residual ratio X of silica A: 70% or more. Residual ratio Y of silica B: 30% or more. Ratio (residual ratio X/residual ratio Y): 1.0 to 3.0.

### CROSS-REFERENCE TO RELATED APPLICATION

This application is based upon and claims the benefit of priority from Japanese Patent Application No. 2021-156537, filed on Sep. 27, 2021, the entire contents of which are incorporated herein by reference.

### FIELD

Embodiments described herein relate to a toner, a toner cartridge, and an image forming apparatus, and method of making the toner.

### BACKGROUND

A toner containing a crystalline polyester resin is known. A low-temperature fixing toner containing a crystalline polyester resin is excellent in low-temperature fixability.

However, when an image forming apparatus in which the low-temperature fixing toner is adopted is operated in a high-temperature environment, the following problems occur.
As a temperature in a machine body of the image forming apparatus increases, a developer containing the low-temperature fixing toner becomes a cake. As a result, the caked developer is clogged in a conveyance unit in a developing device, thereby causing an image defect.
Since hygroscopicity of the crystalline polyester resin is high, a charge amount of the toner decreases, and toner scattering deteriorates. As a result, toner contamination occurs in the machine body.

Therefore, it is very difficult to maintain storage stability and the charge amount in a high-temperature environment while maintaining the low-temperature fixability in the low-temperature fixing toner. In particular, in an image forming apparatus provided with a recycling system, a toner from which an external additive is detached from a surface may return to the developing device to be recycled. Therefore, caking and a decrease in charge amount are more likely to occur.

### DESCRIPTION OF THE DRAWINGS

FIG. 1 is a diagram illustrating an example of a schematic structure of an image forming apparatus according to an embodiment;

FIG. 2 is a perspective view of a developing device;

FIG. 3 is a side view of the developing device;

FIG. 4 is a diagram illustrating an example of a schematic structure of an image forming apparatus according to another embodiment; and

FIG. 5 is a perspective view of a modification of a developing device of FIG. 4.

### DETAILED DESCRIPTION

In general, according to one embodiment, a toner that is excellent in low-temperature fixability, excellent in storage stability in a high-temperature environment even when recycled, and is capable of sufficiently maintaining a charge amount, and a toner cartridge and an image forming apparatus in which the toner is accommodated are provided.

According to an embodiment, a toner contains: a toner mother particle; and an external additive adhered to a surface of the toner mother particle.

The toner mother particle contains a crystalline polyester resin, an ester wax, and a colorant.

The external additive contains silica A and monodispersed silica B. The silica A has an average primary particle diameter D₅₀ of 10 nm to 14 nm. The monodispersed silica B has an average primary particle diameter D₅₀ of 90 nm to 150 nm.

The ester wax is a condensation polymer of a first monomer group and a second monomer group. The first monomer group includes at least three types of carboxylic acids. The second monomer group includes at least three types of alcohols.

A ratio of a carboxylic acid having 18 or less carbon atoms in the first monomer group is 5% by mass or less with respect to 100% by mass of the first monomer group. A ratio of an alcohol having 18 or less carbon atoms in the second monomer group is 20% by mass or less with respect to 100% by mass of the second monomer group.

A ratio of a carboxylic acid having Cₙ carbon atoms, which is a maximum content in the first monomer group, is 70% by mass to 95% by mass with respect to 100% by mass of the first monomer group. A ratio of an alcohol having Cₘ carbon atoms, which is a maximum content in the second monomer group, is 70% by mass to 90% by mass with respect to 100% by mass of the second monomer group.

A content of the silica A is 0.1 parts by mass to 0.8 parts by mass with respect to 100 parts by mass of the toner mother particle.

A content of the silica B is 0.3 parts by mass to 1.2 parts by mass with respect to 100 parts by mass of the toner mother particle.

A ratio of the content of the silica B to the content of the silica A is 1.0 to 5.0.

A residual ratio X of the silica A calculated according to the following equation (1) is 70% or more.

A residual ratio Y of the silica B calculated according to the following equation (2) is 30% or more.

A ratio of the residual ratio X to the residual ratio Y is 1.0 to 3.0.

Residual Ratio X=(Nₐ₂/Nₐ₁)×100 Equation (1)

Residual Ratio Y=(N_{b2}/N_{b1})×100 Equation (2)

In the equation (1), Nₐ₁ is the number of adhered silica A measured for a toner according to an embodiment, and Nₐ₂ is the number of adhered silica A measured for a particle z obtained by the following method Z.

In the equation (2), N_{b1} is the number of adhered silica B measured for the toner according to the embodiment, and N_{b2} is the number of adhered silica B measured for the particle z obtained by the following method Z.

Method Z: executing an ultrasonic treatment on an aqueous liquid containing the toner according to the embodiment, water, and a surfactant at 20° C. and 1000 Hz for 10 minutes, then centrifuging the obtained aqueous liquid at 20° C. and 1000 rpm for 15 minutes, removing the separated external additive, and then executing drying to obtain the particle z.

Hereinafter, a toner according to an embodiment will be described.

The toner according to the embodiment contains a toner mother particle and an external additive.

The toner mother particle contains a crystalline polyester resin, an ester wax, and a colorant.

The external additive contains silica A and monodispersed silica B. The silica A has an average primary particle diameter D₅₀ of 10 nm to 14 nm. The monodispersed silica B has an average primary particle diameter D₅₀ of 90 nm to 150 nm.

The crystalline polyester resin will be described.

The crystalline polyester resin functions as a binder resin. In the embodiment, a polyester resin, in which a ratio of a softening temperature to a melting temperature (softening temperature/melting temperature) is 0.8 to 1.2, is referred to as a “crystalline polyester resin”.

A polyester resin, in which the ratio of the softening temperature to the melting temperature (softening temperature/melting temperature) is less than 0.8 or more than 1.2, is referred to as an “amorphous polyester resin”.

Examples of the crystalline polyester resin include a condensation polymer of a dihydric or polyhydric alcohol and a dihydric or polycarboxylic acid.

Examples of the dihydric or polyhydric alcohol include ethylene glycol, 1,2-propylene glycol, 1,3-propylene glycol, 1,4-butanediol, 1,5-pentanediol, 1,6-hexanediol, neopentyl glycol, 1,4-butenediol, polyoxypropylene, polyoxyethylene, glycerin, pentaerythritol, and trimethylolpropane. As the dihydric or polyhydric alcohol, 1,4-butanediol and 1,6-hexanediol are preferable.

Examples of the dihydric or polycarboxylic acid include: adipic acid, oxalic acid, malonic acid, maleic acid, fumaric acid, citraconic acid, itaconic acid, glutaconic acid, succinic acid, phthalic acid, isophthalic acid, terephthalic acid, sebacic acid, azelaic acid, succinic acid substituted with an alkyl group or an alkenyl group, cyclohexanedicarboxylic acid, trimellitic acid, and pyromellitic acid; acid anhydrides thereof; and esters thereof.

Examples of the succinic acid substituted with an alkyl group or an alkenyl group include succinic acid substituted with an alkyl group or an alkenyl group having 2 to 20 carbon atoms. Examples thereof include n-dodecenyl succinic acid and n-dodecyl succinic acid. As the dihydric or polycarboxylic acid, fumaric acid is preferable.

However, the crystalline polyester resin is not limited to the condensation polymer of the dihydric or polyhydric alcohol and the dihydric or polycarboxylic acid exemplified here. Any of the above crystalline polyester resins may be used alone, or two or more thereof may be used in combination.

A mass average molecular weight of the crystalline polyester resin is preferably 6×10³ to 18×10³, and more preferably 8×10³ to 14×10³. When the mass average molecular weight of the crystalline polyester resin is equal to or greater than the above-mentioned lower limit, the toner is further excellent in low-temperature fixability. When the mass average molecular weight of the crystalline polyester resin is equal to or less than the above-mentioned upper limit, the toner is also excellent in offset resistance.

In the present specification, the mass average molecular weight is a value obtained by gel permeation chromatography in terms of polystyrene.

The melting point of the crystalline polyester resin is preferably 60° C. to 120° C., more preferably 70° C. to 115° C., and still more preferably 80° C. to 110° C. When the melting point of the crystalline polyester resin is equal to or higher than the above-mentioned lower limit, the toner is further excellent in heat resistance. When the melting point of the crystalline polyester resin is equal to or lower than the above-mentioned upper limit, the toner is further excellent in low-temperature fixability.

The melting point of the crystalline polyester resin can be measured by, for example, a differential scanning calorimeter (DSC).

The toner mother particle may further contain a binder resin other than the crystalline polyester resin as long as an effect disclosed in the embodiment can be obtained.

Examples of other binder resins include an amorphous polyester resin, a styrene resin, an ethylene resin, an acrylic resin, a phenolic resin, an epoxy resin, an allyl phthalate resin, a polyamide resin, and a maleic acid resin. Among these, the amorphous polyester resin is preferable.

However, other binder resins are not limited to these exemplified resins. Any of the above other binder resins may be used alone, or two or more thereof may be used in combination.

Examples of the amorphous polyester resin include a condensation polymer of a dihydric or polycarboxylic acid and a dihydric alcohol.

Examples of the dihydric or polycarboxylic acid include a dihydric or polycarboxylic acid, an acid anhydride of a dihydric or polycarboxylic acid, and an ester of a dihydric or polycarboxylic acid. Examples of the ester of a dihydric or polycarboxylic acid include a lower alkyl (having 1 to 12 carbon atoms) ester of a dihydric or polycarboxylic acid.

Examples of the dihydric alcohol include ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, polytetramethylene glycol, bisphenol A, hydrogenated bisphenol A, and an alkylene oxide adduct of bisphenol A. However, the dihydric alcohol is not limited to these exemplified alcohols.

Examples of the alkylene oxide adduct of bisphenol A include a compound obtained by adding an average of 1 to 10 moles of an alkylene oxide having 2 to 3 carbon atoms to bisphenol A. Examples of the alkylene oxide adduct of bisphenol A include polyoxypropylene(2.2)-2,2-bis(4-hydroxyphenyl)propane, polyoxypropylene(3.3)-2,2-bis(4-hydroxyphenyl)propane, polyoxyethylene(2.0)-2,2-bis(4-hydroxyphenyl)propane, polyoxypropylene(2.0)-polyoxyethylene(2.0)-2,2-bis(4-hydroxyphenyl)propane, and polyoxypropylene(6)-2,2-bis(4-hydroxyphenyl)propane.

As the dihydric alcohol, the alkylene oxide adduct of bisphenol A is preferable. Any of the above dihydric alcohols may be used alone, or two or more thereof may be used in combination.

A mass average molecular weight of the amorphous polyester resin is preferably 6×10³ to 18×10³, and more preferably 8×10³ to 14×10³. When the mass average molecular weight of the amorphous polyester resin is equal to or greater than the above-mentioned lower limit, the toner is further excellent in low-temperature fixability. When the mass average molecular weight of the amorphous polyester resin is equal to or less than the above-mentioned upper limit, the toner is also excellent in offset resistance.

The melting temperature of the amorphous polyester resin is preferably 60° C. to 120° C., and more preferably 70° C. to 115° C. When the melting temperature of the amorphous polyester resin is equal to or higher than the lower limit of the above-mentioned numerical range, the toner is less likely to be adhered to a roller during fixing. As a result, the offset resistance at a high temperature is excellent. The toner is further excellent in heat resistance. When the melting temperature of the amorphous polyester resin is equal to or lower than the upper limit of the above-mentioned numerical range, the toner is further excellent in low-temperature fixability.

The melting temperature of the amorphous polyester resin can be measured by, for example, a constant test force extrusion type capillary rheometer (flowtester).

The other binder resins are obtained by, for example, polymerizing a vinyl polymerizable monomer alone or in a plurality of types.

Examples of the vinyl polymerizable monomer include an aromatic vinyl monomer, an ester monomer, a carboxylic acid-containing monomer, and an amine monomer.

Examples of the aromatic vinyl monomer include styrene, methyl styrene, methoxystyrene, phenylstyrene, chlorostyrene, and derivatives thereof.

Examples of the ester monomer include methyl acrylate, ethyl acrylate, butyl acrylate, methyl methacrylate, ethyl methacrylate, butyl methacrylate, and derivatives thereof.

Examples of the carboxylic acid-containing monomer include acrylic acid, methacrylic acid, fumaric acid, maleic acid, and derivatives thereof.

Examples of the amine monomer include aminoacrylate, acrylamide, methacrylamide, vinylpyridine, vinylpyrrolidone, and derivatives thereof.

The other binder resins may be obtained by polycondensation of a polymerizable monomer component formed of an alcohol component and a carboxylic acid component. In polymerization of the polymerizable monomer component, various auxiliary agents such as a chain transfer agent, a crosslinking agent, a polymerization initiator, a surfactant, an aggregating agent, a pH adjusting agent, and an antifoaming agent may be used.

The ester wax will be described.

The ester wax is formed of two or more types of ester compounds having different numbers of carbon atoms. Since the toner mother particle contains the ester wax, the toner is excellent in heat resistance.

The ester wax is a condensation polymer of a first monomer group and a second monomer group.

The first monomer group will be described.

The first monomer group includes at least three types of carboxylic acids. Therefore, the toner is less likely to aggregate and is excellent in heat resistance. The number of types of carboxylic acids in the first monomer group is preferably 7 or less, and more preferably 5 or less, from the viewpoint of easy availability of the ester wax.

A ratio of the carboxylic acid having Cₙ carbon atoms, which is a maximum content, is 70% by mass to 95% by mass, preferably 80% by mass to 95% by mass, and more preferably 85% by mass to 95% by mass with respect to 100% by mass of the first monomer group. Since the ratio of the carboxylic acid having Cₙ carbon atoms is equal to or greater than the above-mentioned lower limit, a maximum peak in a carbon atom distribution of the ester wax is located on a sufficiently high carbon atom side. As a result, the toner is excellent in fluidity (conveyance property of developer).

Since the ratio of the carboxylic acid having Cₙ carbon atoms is equal to or less than the above-mentioned upper limit, the toner is excellent in offset resistance at a low temperature. In addition, the ester wax is easily available.

A ratio of a carboxylic acid having 18 or less carbon atoms in the first monomer group is 5% by mass or less, preferably 0% by mass to 5% by mass, and more preferably 0% by mass to 1% by mass with respect to 100% by mass of the first monomer group. When the ratio of the carboxylic acid having 18 or less carbon atoms is equal to or greater than the above-mentioned lower limits, the ester wax is easily available.

Since the ratio of the carboxylic acid having 18 or less carbon atoms is equal to or less than the above-mentioned upper limits, the toner is excellent in offset resistance at a low temperature.

A content of the carboxylic acid having each number of carbon atoms in the first monomer group can be measured by, for example, executing mass spectrometry by field desorption mass spectrometry (FD-MS) on a product obtained after a methanolysis reaction of the ester wax. A total ion strength in the carboxylic acid having each number of carbon atoms in the product obtained by the measurement by FD-MS is defined as 100. A relative value of the ion strength in the carboxylic acid having each number of carbon atoms with respect to the total ion strength is calculated. The relative value is defined as the content of the carboxylic acid having each number of carbon atoms in the first monomer group. The number of carbon atoms in the carboxylic acid having the maximum relative value is represented by Cₙ.

The carboxylic acid in the first monomer group is preferably a long-chain carboxylic acid, and more preferably a long-chain alkylcarboxylic acid, from the viewpoint of easy availability of the ester wax. The long-chain carboxylic acid is appropriately selected such that the ester wax satisfies a predetermined requirement.

The long-chain carboxylic acid is preferably a long-chain carboxylic acid having 19 to 28 carbon atoms, and more preferably a long-chain carboxylic acid having 20 to 24 carbon atoms. When the number of carbon atoms of the long-chain carboxylic acid is equal to or greater than the above-mentioned lower limit, the toner is further excellent in heat resistance. When the number of carbon atoms of the long-chain carboxylic acid is equal to or less than the above-mentioned upper limit, the toner is further excellent in low-temperature fixability.

Examples of the long-chain alkylcarboxylic acid include palmitic acid, stearic acid, arachidic acid, behenic acid, lignoceric acid, cerotic acid, and montanic acid.

The second monomer group will be described.

The second monomer group includes at least three types of alcohols. Therefore, the toner is less likely to aggregate and is excellent in heat resistance. The number of types of alcohols in the second monomer group is preferably 5 or less from the viewpoint of easy availability of the ester wax.

A ratio of the alcohol having Cₘ carbon atoms, which is a maximum content, is 70% by mass to 90% by mass, preferably 80% by mass to 90% by mass, and more preferably 85% by mass to 90% by mass with respect to 100% by mass of the second monomer group. Since the ratio of the alcohol having Cₘ carbon atoms is equal to or greater than the above-mentioned lower limit, a maximum peak in a carbon atom distribution of the ester wax is located on the sufficiently high carbon atom side. As a result, the toner is excellent in fluidity (conveyance property of developer).

Since the ratio of the alcohol having Cₘ carbon atoms is equal to or less than the above-mentioned upper limit, the toner is excellent in offset resistance at a low temperature. In addition, the ester wax is easily available.

A ratio of an alcohol having 18 or less carbon atoms in the second monomer group is 20% by mass or less, preferably 10% by mass to 20% by mass, and more preferably 15% by mass to 20% by mass with respect to 100% by mass of the second monomer group. When the ratio of the alcohol having 18 or less carbon atoms is equal to or greater than the above-mentioned lower limit, the ester wax is easily available.

Since the ratio of the alcohol having 18 or less carbon atoms is equal to or less than the above-mentioned upper limit, the toner is excellent in offset resistance at a low temperature.

A content of the alcohol having each number of carbon atoms in the second monomer group can be measured by, for example, executing mass spectrometry by FD-MS on a product obtained after a methanolysis reaction of the ester wax. A total ion strength of the alcohol having each number of carbon atoms in the product obtained by the measurement by FD-MS is defined as 100. A relative value of the ion strength of the alcohol having each number of carbon atoms with respect to the total ion strength is calculated. The relative value is defined as the content of the alcohol having each number of carbon atoms in the second monomer group. The number of carbon atoms in the alcohol having the maximum relative value is represented by Cₘ.

The alcohol in the second monomer group is preferably a long-chain alcohol, and more preferably a long-chain alkyl alcohol, from the viewpoint of easy availability of the ester wax. The long-chain alcohol is appropriately selected such that the ester wax satisfies a predetermined requirement. The long-chain alcohol is preferably a long-chain alcohol having 19 to 28 carbon atoms, and more preferably a long-chain alcohol having 20 to 22 carbon atoms. When the number of carbon atoms of the long-chain alcohol is equal to or greater than the above-mentioned lower limit, the heat resistance of the ester wax is improved, and the toner is further excellent in heat resistance. When the number of carbon atoms of the long-chain alcohol is equal to or less than the above-mentioned upper limit, the toner is further excellent in low-temperature fixability.

Examples of the long-chain alkyl alcohol include palmityl alcohol, stearyl alcohol, arachidyl alcohol, behenyl alcohol, lignoceryl alcohol, ceryl alcohol, and montanyl alcohol.

A content of the ester compound having each number of carbon atoms in the ester wax can be measured by, for example, mass spectrometry by FD-MS. A total ion strength of the ester compound having each number of carbon atoms in the ester wax obtained by the measurement by FD-MS is defined as 100. A relative value of the ion strength of the ester compound having each number of carbon atoms with respect to the total ion strength is calculated. The relative value is defined as the content of the ester compound having each number of carbon atoms in the ester wax. The number of carbon atoms in the ester compound having the maximum relative value is represented by C₁.

A method of preparing the ester wax will be described.

The ester wax can be prepared by, for example, subjecting the long-chain carboxylic acid and the long-chain alcohol to an esterification reaction. In the esterification reaction, at least three types of long-chain alkylcarboxylic acids and at least three types of long-chain alkyl alcohols are preferably used from the viewpoint of easily obtaining an ester wax satisfying the predetermined requirement. When each usage amount of at least three types of long-chain alkylcarboxylic acids and at least three types of long-chain alkyl alcohols is adjusted, the carbon atom distribution of the ester compound contained in the ester wax can be adjusted. The esterification reaction is preferably executed while executing heating under a nitrogen stream.

An esterification reaction product may be purified by dissolving the esterification reaction product in a solvent containing ethanol, toluene, or the like, further adding a basic aqueous solution such as a sodium hydroxide aqueous solution, and separating the esterification reaction product into an organic layer and an aqueous layer. The ester wax can be obtained by removing the aqueous layer. The purification operation is preferably repeated a plurality of times.

The colorant will be described.

The colorant is not particularly limited. Examples of the colorant include carbon black, and pigments and dyes of cyan, yellow, and magenta.

Examples of the carbon black include aniline black, lamp black, acetylene black, furnace black, thermal black, channel black, and Ketjen black.

Examples of the pigments and dyes include fast yellow G, benzidine yellow, chrome yellow, quinoline yellow, indofast orange, irgazine red, carmine FB, permanent bordeaux FRR, pigment orange R, lithol red 2G, lake red C, rhodamine FB, rhodamine B Lake, DuPont oil red, phthalocyanine blue, pigment blue, aniline blue, calcoil blue, ultramarine blue, brilliant green B, phthalocyanine green, malachite green oxalate, methylene blue chloride, rose bengal, and quinacridone.

Examples of the colorant include, in terms of color index number: C.I. pigment blacks 1, 6, and 7; C.I. pigment yellows 1, 12, 14, 17, 34, 74, 83, 97, 155, 180, and 185; C.I. pigment oranges 48 and 49; C.I. pigment reds 5, 12, 31, 48, 48:1, 48:2, 48:3, 48:4, 48:5, 49, 53, 53:1, 53:2, 53:3, 57, 57:1, 81, 81:4, 122, 146, 150, 177, 185, 202, 206, 207, 209, 238, and 269; C.I. pigment blues 15, 15:1, 15:2, 15:3, 15:4, 15:5, 15:6, 75, 76, and 79; C.I. pigment greens 1, 7, 8, 36, 42, and 58; C.I. pigment violets 1, 19, and 42; and C.I. acid red 52. However, the colorant is not limited to these exemplified colorants.

Any of the above colorants may be used alone, or two or more thereof may be used in combination.

The toner mother particle may further contain components other than the binder resin, the ester wax, and the colorant as long as the effect disclosed in the embodiment can be exhibited.

Examples of other components include additives such as a charge control agent, a surfactant, a basic compound, an aggregating agent, a pH adjusting agent, and an antioxidant. However, the additives are not limited to these exemplified additives. Any of the above additives may be used alone, or two or more thereof may be used in combination.

The charge control agent will be described.

When the toner mother particle contains the charge control agent, the toner is easily transferred to a recording medium such as paper. Examples of the charge control agent include a metal-containing azo compound, a metal-containing salicylic acid derivative compound, a metal oxide hydrophobized product, and an inclusion compound of a polysaccharide. As the metal-containing azo compound, a complex or a complex salt in which the contained metal is iron, cobalt, or chromium, or a mixture of the complex and the complex salt is preferable. As the metal-containing salicylic acid derivative compound and the metal oxide hydrophobized product, a complex or a complex salt in which the contained metal is zirconium, zinc, chromium, or boron, or a mixture of the complex and the complex salt is preferable. As the inclusion compound of a polysaccharide, an inclusion compound of a polysaccharide containing aluminum (Al) and magnesium (Mg) is preferable.

A composition of the toner mother particle will be described.

A content of the crystalline polyester resin is preferably 5% by mass to 25% by mass, more preferably 5% by mass to 20% by mass, and still more preferably 5% by mass to 15% by mass with respect to 100% by mass of the toner mother particle. When the content of the crystalline polyester resin is equal to or greater than the above-mentioned lower limit, the toner is further excellent in low-temperature fixability. When the content of the crystalline polyester resin is equal to or less than the above-mentioned upper limit, the toner is excellent in offset resistance.

A content of the ester wax is preferably 3% by mass to 15% by mass, more preferably 3% by mass to 13% by mass, and still more preferably 5% by mass to 10% by mass with respect to 100% by mass of the toner mother particle. When the content of the ester wax is equal to or greater than the above-mentioned lower limit, the toner is further excellent in heat resistance. When the content of the ester wax is equal to or less than the above-mentioned upper limit, the toner is further excellent in low-temperature fixability. In addition, the charge amount is likely to be sufficiently maintained.

When the toner mother particle contains an amorphous polyester resin, a content of the amorphous polyester resin is preferably 60% by mass to 90% by mass, more preferably 65% by mass to 85% by mass, and still more preferably 70% by mass to 80% by mass with respect to 100% by mass of the toner mother particle. When the content of the amorphous polyester resin is equal to or greater than the above-mentioned lower limit, the toner is excellent in offset resistance. When the content of the amorphous polyester resin is equal to or less than the above-mentioned upper limit, the toner is further excellent in low-temperature fixability.

A content of the colorant is preferably 2% by mass to 13% by mass, and more preferably 3% by mass to 8% by mass with respect to 100% by mass of the toner mother particle. When the content of the colorant is equal to or greater than the above-mentioned lower limit, the toner is excellent in color reproducibility. When the content of the colorant is equal to or less than the above-mentioned upper limit, dispersibility of the colorant is excellent. In addition, the charge amount of the toner is easily controlled.

The external additive will be described.

The silica A is usually a secondary particle of silica in which two or more silica particles are coalesced or aggregated. The secondary particle of silica has an indefinite shape. A specific shape of the secondary particle is not particularly limited. The secondary particle may have a polygonal columnar shape, a polyhedral shape, or an ellipsoidal shape.

On the other hand, the silica B contains single silica particles. That is, the silica B is a primary particle of silica. The silica B is adhered to a surface of the toner mother particle in a monodispersed state. The primary particle of silica means a single particle made of silica. The primary particle of silica has preferably a spherical shape, and more preferably a true spherical shape.

The average primary particle diameter D₅₀ of the silica A is a value measured for a composite particle in which two or more silica particles are coalesced or aggregated. In addition, the average primary particle diameter D₅₀ of the silica B is a value measured for a single silica particle.

Since the external additive contains the silica A, the toner according to the embodiment has good fluidity and chargeability. The fluidity and chargeability of a recycled toner are also improved.

The average primary particle diameter D₅₀ of the silica A is 10 nm to 14 nm, preferably 11 nm to 13 nm, and more preferably 11 nm to 12 nm. Since the average primary particle diameter D₅₀ of the silica A is equal to or greater than the above-mentioned lower limit, the silica A is appropriately and sufficiently adhered to the surface of the toner mother particle. As a result, the silica A can exhibit a charge-imparting effect, and the chargeability of the toner is improved. Therefore, contamination in the machine body due to scattering of the recycled toner is reduced.

Since the average primary particle diameter D₅₀ of the silica A is equal to or less than the above-mentioned upper limit, the silica A is less likely to be embedded in the surface of the toner mother particle. Therefore, the toner is excellent in fluidity. Therefore, contamination in the machine body due to scattering of the recycled toner is reduced.

A content of the silica A is 0.1 parts by mass to 0.8 parts by mass, preferably 0.3 parts by mass to 0.6 parts by mass, and more preferably 0.4 parts by mass to 0.5 parts by mass with respect to 100 parts by mass of the toner mother particle.

Since the content of the silica A is equal to or greater than the above-mentioned lower limit, the fluidity of the toner is improved. Therefore, the developer is excellent in conveyance property. Since the chargeability of the toner is improved, the contamination in the machine body due to scattering of the recycled toner is reduced.

Since the content of the silica A is equal to or less than the above-mentioned upper limit, the charge amount of the toner is not excessively high. Therefore, an image density in image formation using the recycled toner is sufficiently ensured.

Since the external additive contains the silica B, the external additive can exhibit a spacing effect between toners. Therefore, the toner according to the embodiment is less likely to aggregate and has good fluidity. In addition, soft caking of the toner is less likely to occur.

The average primary particle diameter D₅₀ of the silica B is 90 nm to 150 nm, preferably 100 nm to 140 nm, and more preferably 115 nm to 130 nm. Since the average primary particle diameter D₅₀ of the silica B is equal to or greater than the above-mentioned lower limit, the spacing effect is exhibited. As a result, the toner is less likely to aggregate, and has good heat resistance and fluidity.

Since the average primary particle diameter D₅₀ of the silica B is equal to or less than the above-mentioned upper limit, the improvement of the chargeability by the silica A is hardly inhibited. As a result, the contamination in the machine body due to scattering of the recycled toner is reduced.

A content of the silica B is 0.3 parts by mass to 1.2 parts by mass, preferably 0.5 parts by mass to 1.0 part by mass, and more preferably 0.7 parts by mass to 0.9 parts by mass with respect to 100 parts by mass of the toner mother particle.

Since the content of the silica B is equal to or greater than the above-mentioned lower limit, the spacing effect is exhibited. As a result, the toner is less likely to aggregate, and has good heat resistance and fluidity.

Since the content of the silica B is equal to or less than the above-mentioned upper limit, the improvement of the chargeability by the silica A is hardly inhibited. As a result, the contamination in the machine body due to scattering of the recycled toner is reduced.

The recycled toner during recycling includes a toner in which an external additive is detached from a surface, such as a transfer remaining toner or a fogging toner. Since a low-temperature fixing toner is softened at a low temperature, the low-temperature fixing toner is likely to aggregate. Therefore, the fluidity, chargeability, and heat resistance of the low-temperature fixing toner are likely to be reduced as compared with those of general purpose toners. As a result, in image formation using the recycled toner of the low-temperature fixing toner, contamination in the machine body due to toner scattering and a decrease in image density are likely to occur.

To solve this problem, the toner according to the embodiment contains silica A having a relatively small average primary particle diameter D₅₀. Therefore, the fluidity and the chargeability of the recycled toner are improved. In addition, the toner according to the embodiment contains silica B having a relatively large average primary particle diameter D₅₀. Therefore, silica having a relatively large size is present on the surface of the toner mother particle. As a result, blocking caused by coalescence of toner particles due to heat or stress can be prevented. Therefore, the fluidity of the recycled toner and the conveyance property of the developer in a high-temperature environment are improved.

As described above, in the toner according to the embodiment, since the external additive contains two types of silica A and silica B, the toner characteristics in a case of recycling are improved.

A ratio of the content of the silica B to the content of the silica A (content of silica B/content of silica A) is 1.0 to 5.0, preferably 1.5 to 4.0, and more preferably 2.0 to 3.0. Since the ratio is equal to or greater than the above-mentioned lower limit, the charge amount of the toner is not excessively high. Therefore, the image density in the image formation using the recycled toner is sufficiently ensured.

Since the ratio is equal to or less than the above-mentioned upper limit, the chargeability of the toner is improved. As a result, the contamination in the machine body due to scattering of the recycled toner is reduced.

A total of the content of the silica A and the content of the silica B is preferably 0.5 parts by mass to 1.7 parts by mass, and more preferably 0.8 parts by mass to 1.4 parts by mass with respect to 100 parts by mass of the toner mother particle. When the total of the content of the silica A and the content of the silica B is equal to or greater than the above-mentioned lower limit, the toner is further excellent in storage stability. When the total of the content of the silica A and the content of the silica B is equal to or less than the above-mentioned upper limit, the toner is likely to be sufficiently melted at the time of fixing.

In the toner according to the embodiment, a residual ratio X of the silica A is 70% or more, preferably 75% to 100%, and more preferably 85% to 95%. When the residual ratio X is equal to or greater than the above-mentioned lower limit, the chargeability of the toner is improved. As a result, the contamination in the machine body due to scattering of the recycled toner is reduced. When the residual ratio X is equal to or less than the above-mentioned upper limit, the toner is easily produced.

In the toner according to the embodiment, a residual ratio Y of the silica B is 30% or more, preferably 40% to 90%, and more preferably 50% to 80%. Since the residual ratio Y is equal to or greater than the above-mentioned lower limit, the spacing effect is exhibited. As a result, the toner is less likely to aggregate, and has good fluidity. When the residual ratio Y is equal to or less than the above-mentioned upper limit, the toner is easily produced.

A ratio of the residual ratio X to the residual ratio Y (residual ratio X/residual ratio Y) is 1.0 to 3.0, preferably 1.3 to 2.7, and more preferably 1.6 to 2.4. When the ratio is equal to or greater than the above-mentioned lower limit, the chargeability of the toner is improved. As a result, the contamination in the machine body due to scattering of the recycled toner is reduced.

Since the ratio is equal to or less than the above-mentioned upper limit, the charge amount of the toner is not excessively high. Therefore, the image density in the image formation using the recycled toner is sufficiently ensured.

The residual ratio X is calculated according to the following equation (1).

Residual Ratio X=(Nₐ₂/Nₐ₁)×100 Equation (1)

In the equation (1), Nₐ₁ is the number of adhered silica A measured for the toner according to the embodiment, and Nₐ₂ is the number of adhered silica A measured for a particle z obtained by the following method Z.

Method Z: executing an ultrasonic treatment on an aqueous liquid containing the toner according to the embodiment, water, and a surfactant at 20° C. and 1000 Hz for 10 minutes, then centrifuging the obtained aqueous liquid at 20° C. and 1000 rpm for 15 minutes, removing the separated external additive, and then executing drying to obtain the particle z.

The residual ratio Y is calculated according to the following equation (2).

Residual Ratio Y=(N_{b2}/N_{b1})×100 Equation (2)

In the equation (2), N_{b1} is the number of adhered silica B measured for the toner according to the embodiment, and N_{b2} is the number of adhered silica B measured for the particle z obtained by the following method Z.

Method Z: executing an ultrasonic treatment on an aqueous liquid containing the toner according to the embodiment, water, and a surfactant at 20° C. and 1000 Hz for 10 minutes, then centrifuging the obtained aqueous liquid at 20° C. and 1000 rpm for 15 minutes, removing the separated external additive, and then executing drying to obtain the particle z.

In the equations (1) and (2), Nₐ₁, Nₐ₂, N_{b1}, and N_{b2} are obtained by counting the number of adhered silica in a scanning electron microscope (SEM) image.

In the method Z, it is preferable to stir the aqueous liquid containing the toner, water, and the surfactant until a toner layer disappears before the aqueous liquid is subjected to the ultrasonic treatment. The stirring method is not particularly limited. For example, a stirrer can be used.

In the method Z, when removing the detached external additive, a supernatant in a centrifugal tube is preferably removed by decantation. Thereafter, it is also preferable to further add ion exchange water and repeat centrifugation and decantation again. The number of repetition times is not particularly limited, and is preferably two.

It can also be said that the particle z obtained by the method Z is a detached toner in which at least a part of the external additive is detached from the toner according to the embodiment.

The silica A and the silica B are not particularly limited. In general, silica particles can be broadly classified into wet silica and burned silica depending on a producing method. The wet silica can be produced by, for example, a method (liquid phase method) of using, as a raw material, sodium silicate, which uses silica sand, neutralizing an aqueous solution containing sodium silicate to precipitate silica, and filtering and drying the silica. The burned silica (dry silica) is obtained by, for example, reacting silicon tetrachloride in a high-temperature flame. The wet silica and the burned silica are both hydrophobic.

In the silica A and the silica B, a silanol group on the surface of the particle may be hydrophobized with, for example, silane or silicone. A degree of hydrophobization of the hydrophobic silica can be measured by, for example, the following method.

Into a beaker, 50 ml of ion exchange water and 0.2 g of a sample are charged, and methanol is added dropwise from a burette while stirring with a magnetic stirrer. Next, as a methanol concentration in the beaker increases, a powder gradually settles, and a percentage by volume of the methanol in a mixed solution of the methanol and the ion exchange water at the end point at which a total amount of the powder settles is defined as a degree of hydrophobization (%).

When the external additive is removed from the toner according to the embodiment and a particle diameter distribution is obtained by measuring a particle diameter of the external additive, it is considered that at least two maximum peaks of silica derived from the silica A and the silica B are present.

In the particle diameter distribution, it is preferable that at least one maximum peak, among the at least two maximum peaks, is present in each of the ranges of 10 nm to 14 nm and 90 nm to 150 nm. In this case, the average primary particle diameter D₅₀ of the silica A can be a mode value (a modal value) within a range of 10 nm to 14 nm in the particle diameter distribution. The average primary particle diameter D₅₀ of the silica B can be a mode value (a modal value) within a range of 90 nm to 150 nm in the particle diameter distribution.

The particle diameter of each silica particle can be measured by, for example, a laser diffraction particle size distribution measuring device.

However, the external additive may further contain silica other than the silica A and the silica B as long as the effect disclosed in the embodiment can be exhibited. That is, the external additive may contain silica having an average primary particle diameter D₅₀ of more than 14 nm and less than 90 nm within a range in which the effect disclosed in the embodiment can be exhibited.

The external additive may further contain an inorganic oxide other than the silica particle. Examples of other inorganic oxides include strontium titanate, titanium oxide, alumina, and tin oxide.

The silica particle and particles made of the inorganic oxide may be surface-treated with a hydrophobizing agent from the viewpoint of improving stability. Any of the above inorganic oxides may be used alone, or two or more thereof may be used in combination.

The average primary particle diameter D₅₀ of the toner according to the embodiment is preferably 5.8 μm to 10.0 μm, and more preferably 7.0 μm to 9.0 μm. When the average primary particle diameter D₅₀ of the toner based on volume is equal to or greater than the above-mentioned lower limit, the toner is further excellent in fluidity. When the average primary particle diameter D₅₀ of the toner based on volume is equal to or less than the above-mentioned upper limit, sufficient image density is easily ensured.

A method of producing the toner will be described.

The toner according to the embodiment can be produced by mixing the toner mother particle and the external additive. By mixing the toner mother particle and the external additive, the external additive is adhered to the surface of the toner mother particle.

The toner mother particle according to the embodiment can be produced by, for example, a kneading and pulverizing method and a chemical method.

The kneading and pulverizing method will be described.

Examples of the kneading and pulverizing method include a producing method including the following mixing step, kneading step, and pulverizing step. The kneading and pulverizing method may further include the following classifying step as necessary.

Mixing step: a step of mixing at least a crystalline polyester resin, an ester wax, and a colorant to obtain a mixture.
Kneading step: a step of melting and kneading the mixture to obtain a kneaded product.
Pulverizing step: a step of pulverizing the kneaded product to obtain a pulverized product.
Classifying step: a step of classifying the pulverized product.

In the mixing step, raw materials of the toner are mixed to obtain the mixture. In the mixing step, a mixer may be used. The mixer is not particularly limited. In the mixing step, another binder resin and another additive may be used as necessary.

In the kneading step, the mixture obtained in the mixing step is melted and kneaded to obtain the kneaded product. In the kneading step, a kneader may be used. The kneader is not particularly limited.

In the pulverizing step, the kneaded product obtained in the kneading step is pulverized to obtain the pulverized product. In the pulverizing step, a pulverizer may be used. As the pulverizer, various pulverizers such as a hammer mill can be used. The pulverized product obtained by the pulverizer may be further finely pulverized. Various pulverizers can be used for further finely pulverizing the pulverized product. The pulverized product obtained in the pulverizing step may be used as the toner mother particle as it is, or may be used as the toner mother particle through the classifying step as necessary.

In the classifying step, the pulverized product obtained in the pulverizing step is classified. In the classifying step, a classifier may be used. The classifier is not particularly limited.

The chemical method will be described.

In the chemical method, a mixture is obtained by mixing a crystalline polyester resin, an ester wax, a colorant, and if necessary, another binder resin and another additive. Next, the mixture is melted and kneaded to obtain a kneaded product. Next, the kneaded product is pulverized to obtain roughly granulated medium-sized particles. Next, the medium-sized particles are mixed with an aqueous medium to prepare a mixed liquid. Next, the mixed liquid is subjected to mechanical shearing to obtain a fine particle dispersion liquid. Finally, fine particles are aggregated in the fine particle dispersion liquid to obtain a toner mother particle.

A method of adding the external additive will be described (external addition step).

The external additive is stirred with the toner mother particle by, for example, a mixer. The mixer preferably has a temperature control function. A temperature at which the external additive is adhered to the toner mother particle is not particularly limited, and is preferably 15° C. to 30° C., for example. As the temperature at which the external additive is adhered to the toner mother particle is higher, the silica A and the silica B are more likely to be adhered to the toner mother particle. Therefore, the residual ratio X and the residual ratio Y are likely to increase.

An order of adhering the silica A and the silica B is not particularly limited. That is, the silica B may be adhered after the silica A is adhered, the silica A may be adhered after the silica B is adhered, or the silica A and the silica B may be adhered at the same time by stirring.

A stirring speed at which the silica A and the silica B are adhered to the toner mother particle is not particularly limited. The stirring speed is appropriately set according to a scale of a production facility. In a case of a laboratory scale stirrer, for example, 2000 rpm to 3000 rpm is preferable. As the stirring speed at which the external additive is adhered to the toner mother particle is higher, the silica A and the silica B are more likely to be adhered to the toner mother particle. Therefore, the residual ratio X and the residual ratio Y are likely to increase.

A stirring time of the silica A and the silica B is preferably 180 seconds to 480 seconds. When the stirring time of the silica A and the silica B is within the above-mentioned numerical range, the silica A and the silica B are likely to be adhered to the toner mother particle. Therefore, the residual ratio X and the residual ratio Y are likely to increase.

The external additive before stirring may be sieved by a sieving device as necessary. The sieving device is not particularly limited. Various sieving devices can be used.

A toner cartridge according to the embodiment will be described.

The toner cartridge according to the embodiment accommodates the toner according to the embodiment described above. For example, the toner cartridge includes a container, and the toner according to the embodiment is accommodated in the container. The container is not particularly limited, and various containers applicable to an image forming apparatus can be used.

The toner according to the embodiment may be used as a one-component developer, or may be used as a two-component developer in combination with a carrier.

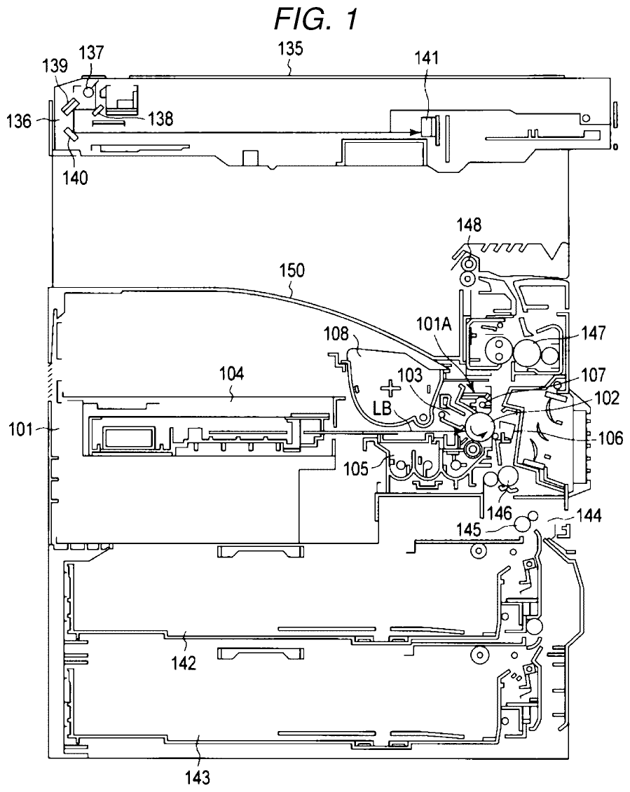

Hereinafter, an image forming apparatus according to the embodiment will be described with reference to the drawings. FIG. 1 is a diagram illustrating an example of a schematic structure of an image forming apparatus capable of recycling a collected toner.

A copying machine main body 101 illustrated in FIG. 1 includes: an image forming unit 101A provided at one side of a central portion; a document placing table 135 provided at an upper surface portion; a scanner 136 provided at a lower side of the document placing table 135; and a plurality of stages of sheet feeding cassettes 142 and 143 provided at a lower side.

The image forming unit 101A includes: a photoconductor drum 102 that is rotatable in an arrow direction; a charger 103 that charges a surface of the photoconductor drum 102; a laser unit 104 that forms an electrostatic latent image on the surface of the photoconductor drum 102; a developing device 105 that develops the electrostatic latent image on the photoconductor drum 102 with a toner; a transfer charger 106 that transfers a toner image on the photoconductor drum 102 to a sheet; a cleaning device 107 that removes the remaining toner on the photoconductor drum 102; and a replenishing container 108 that is provided above the developing device 105.

The charger 103, the laser unit 104, the developing device 105, the transfer charger 106, and the cleaning device 107 are provided around the photoconductor drum 102 in this order along a rotation direction of the photoconductor drum 102.

The replenishing container 108 replenishes the toner according to the embodiment to the developing device 105. The toner according to the embodiment is stored in the replenishing container 108.

The scanner 136 exposes a document on the document placing table 135. The scanner 136 includes: a light source 137 that irradiates the document with light; a first reflection mirror 138 that reflects the light reflected from the document in a predetermined direction; a second reflection mirror 139 and a third reflection mirror 140 that sequentially reflect the light reflected from the first reflection mirror 138; and a light receiving element 141 that receives the light reflected from the third reflection mirror 140.

The sheet feeding cassettes 142 and 143 feed out the sheet to the image forming unit 101A. The sheet is conveyed upward via a conveyance system 144. The conveyance system 144 includes a conveyance roller pair 145, a registration roller pair 146, the transfer charger 106, a fixing roller pair 147, and a sheet discharge roller pair 148.

In the image forming apparatus illustrated in FIG. 1, for example, image formation is executed as follows.

First, a document on the document placing table 135 is irradiated with light from the light source 137. The irradiation light is reflected from the document, passes through the first reflection mirror 138, the second reflection mirror 139, and the third reflection mirror 140 in this order, and is received by the light receiving element 141, so that a document image is read. Next, based on read information of the light receiving element 141, the laser unit 104 irradiates the surface of the photoconductor drum 102 with a laser beam LB.

Here, the surface of the photoconductor drum 102 is negatively charged by the charger 103. When the laser beam LB is emitted from the laser unit 104, the photoconductor drum 102 is exposed, and a potential of the irradiated portion approaches 0. Therefore, in a region corresponding to an image portion of the document, a surface potential of the photoconductor drum 102 approaches 0 according to a density of the image, and an electrostatic latent image is formed.

The electrostatic latent image becomes a toner image by adsorbing the toner at a position facing the developing device 105 by a rotation of the photoconductor drum 102. When a toner image is to be formed, a sheet is supplied from the sheet feeding cassettes 142 and 143 to the conveyance system 144. The sheet is aligned by the registration roller pair 146, and then is fed between the transfer charger 106 and the photoconductor drum 102. Thereafter, the toner image on the photoconductor drum 102 is transferred onto the sheet.

The sheet to which the toner image is transferred is conveyed to the fixing roller pair 147. In the fixing roller pair 147, the sheet is pressurized and heated, and the toner image is fixed to the sheet. The toner according to the embodiment is excellent in low-temperature fixability. Therefore, fixing can be executed at, for example, about 140° C. to 170° C. After the fixing, the sheet is discharged onto a sheet discharge tray 150 via the sheet discharge roller pair 148.

On the other hand, the toner remaining on the surface of the photoconductor drum 102 without being transferred to the sheet is removed by the cleaning device 107. Thereafter, the toner is returned to the developing device 105 by a collecting mechanism 110 and recycled. In the image forming apparatus illustrated in FIG. 1, when the toner in the developing device 105 is consumed, the toner according to the embodiment is newly replenished as a fresh toner from the replenishing container 108.

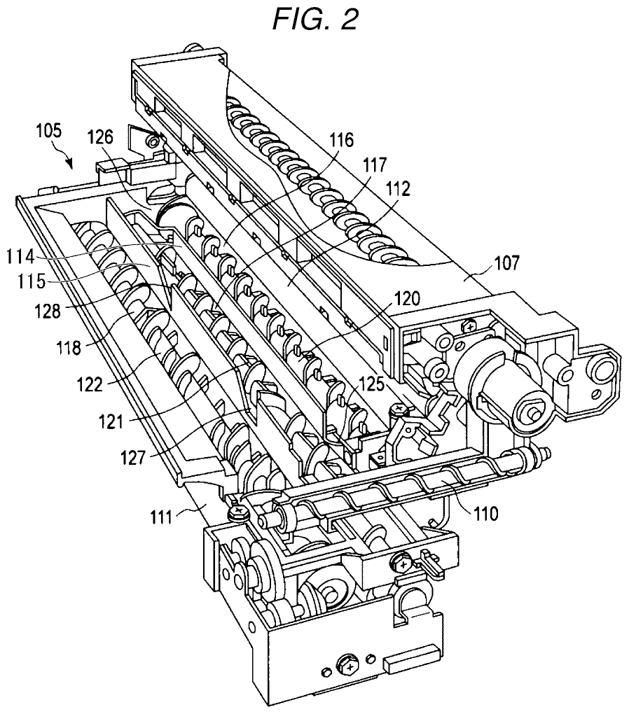

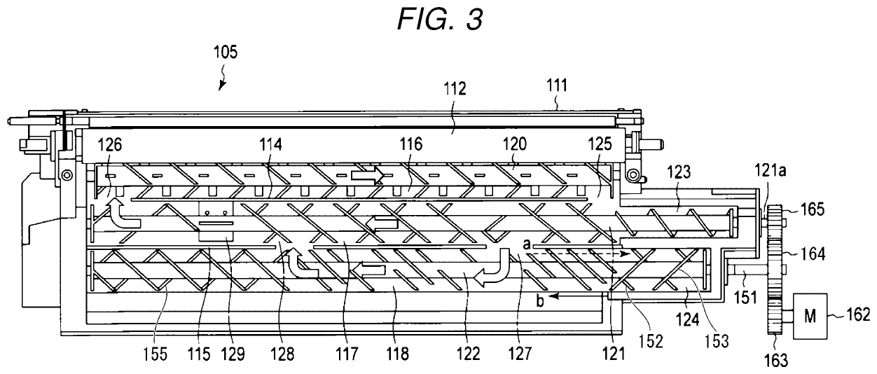

The developing device 105 will be described with reference to FIGS. 2 and 3.

The developing device 105 includes: the collecting mechanism 110 that collects the toner for recycling; a developing container 111 in which the developer containing the toner according to the embodiment is stored; a developing roller 112 that is rotatably provided in the developing container 111; a first partition wall 114 and a second partition wall 115 that form a first chamber 116, a second chamber 117, and a third chamber 118 in the developing container 111; a first mixer 120 that is provided in the first chamber 116; a second mixer 121 that is provided in the second chamber 117; a third mixer 122 that is provided in the third chamber 118; a fresh toner receiving unit 123 that receives the fresh toner supplied from the replenishing container; a recycled toner receiving unit 124; and a toner concentration detector 129.

The developing device 105 is connected to the cleaning device 107 via the collecting mechanism 110. In the developing device 105, the collecting mechanism 110 is an auger to which the toner for recycling is conveyed. However, the collecting mechanism 110 is not limited to the auger.

The cleaning device 107 may be a cleaning blade or a cleaning brush.

The developing roller 112 is disposed at a position facing a lower surface portion of the photoconductor drum. The developing roller 112 supplies the developer to the photoconductor drum by rotating.

A first communication portion 125 is formed on a first end portion side of the first partition wall 114. A second communication portion 126 is formed on a second end portion side of the first partition wall 114. A third communication portion 127 and a fourth communication portion 128 are formed in the second partition wall 115.

The inside of the developing container 111 is partitioned into the first chamber 116, the second chamber 117, and the third chamber 118 by the first partition wall 114 and the second partition wall 115. The first chamber 116, the second chamber 117, and the third chamber 118 are formed substantially parallel to each other along an axial direction of the photoconductor drum 102.

Here, on a sheet surface, in the first partition wall 114, a direction from the second communication portion 126 toward the first communication portion 125 is referred to as a first direction. A direction opposite to the first direction, that is, a direction from the first communication portion 125 toward the second communication portion 126 is referred to as a second direction.

By rotation, the first mixer 120 stirs and conveys the developer in the first direction and supplies the developer to the developing roller 112. The second mixer 121 and the third mixer 122 stir and convey the developer in the second direction and feed the developer to an upstream side of the first mixer 120.

The second mixer 121 and the third mixer 122 are rotationally driven by a driving unit. In the developing device 105, the driving unit includes: a driving motor 162 as a single driving source; and a driving gear 163 rotated by the driving motor 162. A rotary shaft 151 of the third mixer 122 is connected to the driving gear 163 via a large-diameter power transmission gear 164. A rotation shaft 121a of the second mixer 121 is connected to the large-diameter power transmission gear 164 via a small-diameter power transmission gear 165.

In the developing device 105 having the above-described configuration, a speed of conveying the developer by the third mixer 122 is lower than a speed of conveying the developer by the second mixer 121. Therefore, a time of conveying the developer by the third mixer 122 is longer than a time of conveying the developer by the second mixer 121.

Here, in another embodiment, the second mixer 121 and the third mixer 122 may be individually rotationally driven by a plurality of driving motors having different rotation speeds. The third mixer 122 may be provided with a reverse feed blade that conveys the collected toner in a direction opposite to the second direction. In either method, a speed of conveying the collected toner by the third mixer 122 can be made lower than the speed of conveying the developer by the second mixer 121.

Next, a developing operation of the developing device 105 will be described with reference to FIGS. 2 and 3.

In the developing container 111, the developer is stirred and conveyed in the first direction by a rotation of the first mixer 120, and is supplied to the developing roller 112. Thereafter, the developer is supplied to the electrostatic latent image on the photoconductor drum 102 by a rotation of the developing roller 112, and the electrostatic latent image is visualized.

The developer conveyed out from the first mixer 120 is guided into the second chamber 117 through the first communication portion 125. Thereafter, in the second chamber 117, the developer is conveyed in an arrow direction (the second direction) by a rotation of the second mixer 121. The developer conveyed out by the second mixer 121 is fed out to the upstream side of the first mixer 120 through the second communication portion 126, and is conveyed so as to circulate between the first mixer 120 and the second mixer 121.

A part of the developer conveyed by the second mixer 121 is fed into the third chamber 118 through the third communication portion 127 and conveyed in the arrow direction (the second direction). The developer is fed again into the second chamber 117 through the fourth communication portion 128, and is stirred and conveyed by the second mixer 121. Thereafter, the developer is fed to the upstream side of the first mixer 120 through the second communication portion 126.

Here, a toner concentration of the developer stirred and conveyed by the second mixer 121 is detected by the toner concentration detector 129. When the toner concentration detected by the toner concentration detector 129 is equal to or less than a predetermined value, the toner according to the embodiment is replenished from the replenishing container 108. The toner falls into the fresh toner receiving unit 123 of the developing container 111. The fresh toner is stirred and conveyed in the arrow direction (the second direction) by the rotation of the second mixer 121, and is fed to the upstream side of the first mixer 120.

The collected toner collected from the cleaning device 107 by the collecting mechanism 110 falls into the recycled toner receiving unit 124. The collected toner is conveyed in the second direction by a rotation of the third mixer 122. Here, the developer guided through the third communication portion 127 into the third chamber 118 is stirred and conveyed toward the recycled toner receiving unit 124 as indicated by an arrow a by a rotation of a reverse feed blade 153 of the third mixer 122. Thereafter, the developer is stirred and conveyed together with the collected toner in the second direction as indicated by an arrow b by a rotation of a forward feed blade 152. The collected toner is fed to the upstream side of the first mixer 120 through the fourth communication portion 128 and the second communication portion 126 in this order.

The developer and the collected toner may be fed to a downstream side in a conveyance direction without being fed into the second chamber 117 through the fourth communication portion 128. Such developer and collected toner are reversely fed by a rotation of a reverse feed blade 155, returned to the fourth communication portion 128, and fed to the second chamber 117 through the fourth communication portion 128.

In the related art, when a developer containing a toner is recycled, an external additive is easily peeled off from a toner mother particle due to physical stress, and soft caking is remarkably generated. Therefore, there is a problem in that the conveyance property of the developer is reduced, and the charge amount and the scattering amount of the toner are reduced.

In contrast, the toner according to the embodiment is excellent in storage stability in a high-temperature environment even when recycled, and is capable of sufficiently maintaining the charge amount. Therefore, the charge amount and the scattering amount of the toner are sufficiently maintained, and good development is executed.

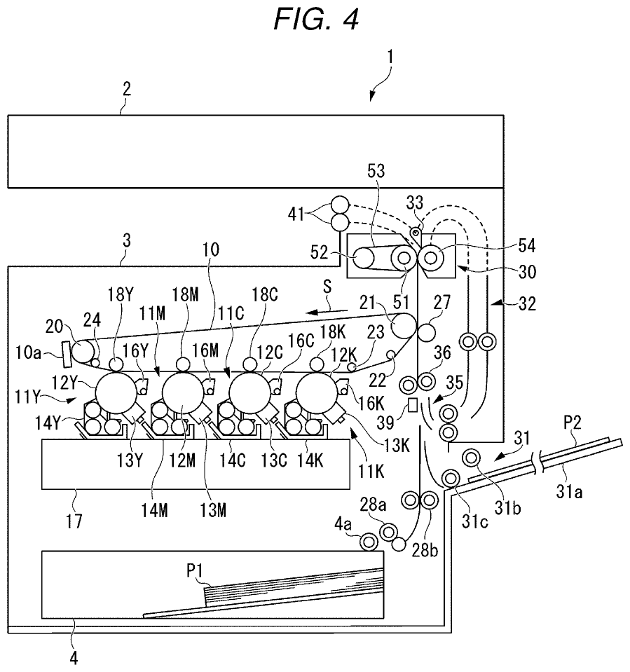

FIG. 4 illustrates an example of an image forming apparatus to which the developer containing the toner according to the embodiment is applied.

The image forming apparatus illustrated in FIG. 4 is in a form in which a toner image is fixed. However, the image forming apparatus according to the embodiment is not limited to this form. An image forming apparatus according to another embodiment may be, for example, in a form of an inkjet image forming apparatus.

An image forming apparatus 1 illustrated in FIG. 4 is a four-drum tandem color copier MFP. The image forming apparatus 1 includes: a scanner unit 2; a sheet discharge unit 3; a sheet feeding cassette 4; an intermediate transfer belt 10; four image forming stations 11Y, 11M, 11C, and 11K disposed along a traveling direction S of the intermediate transfer belt 10; a secondary transfer roller 27; a fixing device 30; and a manual feed mechanism 31.

The intermediate transfer belt 10 is wound around and supported by a driven roller 20 and a backup roller 21. Any tension is applied to the intermediate transfer belt 10 by a first tension roller 22, a second tension roller 23, and a third tension roller 24 in addition to the driven roller 20 and the backup roller 21.

The image forming stations 11Y, 11M, 11C, and 11K respectively have photoconductor drums 12Y, 12M, 12C, and 12K that are in contact with the intermediate transfer belt 10.

Around the photoconductor drums 12Y, 12M, 12C, and 12K, chargers 13Y, 13M, 13C, and 13K, developing devices 14Y, 14M, 14C, and 14K, photoconductor cleaning devices 16Y, 16M, 16C, and 16K, and primary transfer rollers 18Y, 18M, 18C, and 18K are disposed.

The chargers 13Y, 13M, 13C, and 13K negatively charge surfaces of the photoconductor drums 12Y, 12M, 12C, and 12K. Between the chargers 13Y, 13M, 13C, and 13K and the developing devices 14Y, 14M, 14C, and 14K, a laser exposure device 17 irradiates the photoconductor drums 12Y, 12M, 12C, and 12K with exposure light. Electrostatic latent images are formed on the photoconductor drums 12Y, 12M, 12C, and 12K.

The developing devices 14Y, 14M, 14C, and 14K respectively have a two-component developer containing toners of yellow (Y), magenta (M), cyan (C), and black (K) and a carrier. The developing devices 14Y, 14M, 14C, and 14K respectively supply a toner to the electrostatic latent images on the photoconductor drums 12Y, 12M, 12C, and 12K. In this way, the image forming stations 11Y, 11M, 11C, and 11K respectively form single-color images of yellow (Y), magenta (M), cyan (C), and black (K).

The primary transfer rollers 18Y, 18M, 18C, and 18K are provided on the intermediate transfer belt 10 at positions facing the photoconductor drums 12Y, 12M, 12C, and 12K, respectively. The primary transfer rollers 18Y, 18M, 18C, and 18K primarily transfer toner images on the photoconductor drums 12Y, 12M, 12C, and 12K to the intermediate transfer belt 10.

The primary transfer rollers 18Y, 18M, 18C, and 18K are conductive rollers. A primary transfer bias voltage is applied to each of the primary transfer rollers 18Y, 18M, 18C, and 18K.

The secondary transfer roller 27 is disposed at a transfer position where the intermediate transfer belt 10 is supported by the backup roller 21. The backup roller 21 is a conductive roller. A predetermined secondary transfer bias is applied to the backup roller 21.

When sheet paper as a printing object passes between the intermediate transfer belt 10 and the secondary transfer roller 27, the toner image on the intermediate transfer belt 10 is secondarily transferred onto the sheet paper. After completion of the secondary transfer, the intermediate transfer belt 10 is cleaned by a belt cleaner 10a.

The sheet feeding cassette 4 is provided below the laser exposure device 17. The sheet feeding cassette 4 supplies sheet paper P1 toward the secondary transfer roller 27. A pickup roller 4a, a separation roller 28a, a conveyance roller 28b, and a registration roller pair 36 are provided between the sheet feeding cassette 4 and the secondary transfer roller 27.

The manual feed mechanism 31 is provided on one side surface portion of the image forming apparatus 1. The manual feed mechanism 31 is for manually feeding sheet paper P2. In the manual feed mechanism 31, a manual pickup roller 31b and a manual separation roller 31c are provided between a manual feed tray 31a and the registration roller pair 36.

A media sensor 39 that detects a type of the sheet paper is disposed on a vertical conveyance path 35 through which the sheet paper is conveyed from the sheet feeding cassette 4 or the manual feed tray 31a. The image forming apparatus 1 can control a conveyance speed, a transfer condition, a fixing condition, and the like of the sheet paper based on a detection result obtained by the media sensor 39. The sheet paper is conveyed along the vertical conveyance path 35 to the fixing device 30 via the registration roller pair 36 and the secondary transfer roller 27.

The fixing device 30 includes: a fixing belt 53 wound around a pair of a heating roller 51 and a driving roller 52; and a counter roller 54 disposed to face the heating roller 51 via the fixing belt 53. The fixing device 30 can heat a portion of the fixing belt 53 that is in contact with the heating roller 51. The fixing device 30 applies heat and pressure to the sheet paper on which the toner image is transferred between the fixing belt 53 and the counter roller 54, and fixes the toner image to the sheet paper.

The toner according to the embodiment is excellent in low-temperature fixability. Therefore, fixing can be executed at, for example, about 140° C. to 170° C.

A gate 33 is provided downstream of the fixing device 30. The sheet paper is distributed in a direction of a sheet discharge roller 41 or in a direction of a re-conveyance unit 32. The sheet paper distributed to the sheet discharge roller 41 is discharged to the sheet discharge unit 3. On the other hand, the sheet paper distributed to the re-conveyance unit 32 is guided toward the secondary transfer roller 27 again.

In the image forming apparatus 1 illustrated in FIG. 4, the image forming station 11Y includes the photoconductor drum 12Y and a process member integrally with each other, and is detachably adhered to a main body of the image forming apparatus. Examples of the process member include the charger 13Y, the developing device 14Y, and the photoconductor cleaning device 16Y. However, in another embodiment, each of the image forming stations 11Y, 11M, 11C, and 11K may be detachably adhered to the image forming apparatus, or may be detachably adhered to the image forming apparatus as an integrated image forming unit 11.

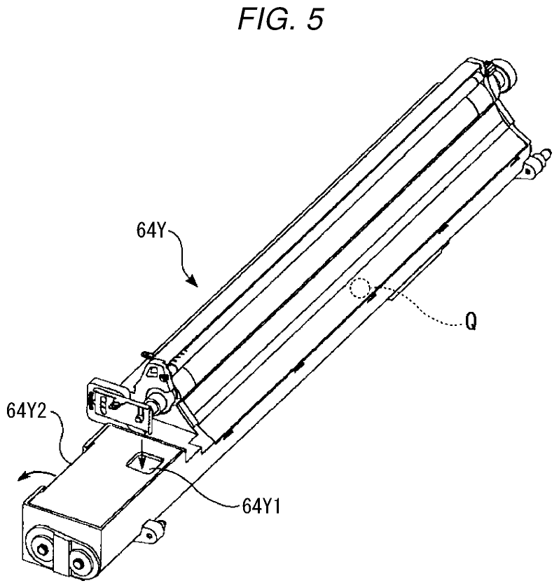

The toner according to the embodiment may be applied to an image forming apparatus in which the developing device 14Y of the image forming apparatus illustrated in FIG. 4 is modified. FIG. 5 illustrates an example of a modification of the developing device applicable to the image forming apparatus illustrated in FIG. 4.

A developing device 64Y illustrated in FIG. 5 accommodates a two-component developer containing a yellow toner and a carrier. The developing device 64Y includes a toner concentration sensor Q. The toner concentration sensor Q detects a decrease in toner concentration. When the developing device 64Y detects a decrease in concentration, the developing device 64Y replenishes the yellow toner from a toner cartridge (not illustrated). In this way, the developing device 64Y can maintain a toner concentration constant.

In addition, the developing device 64Y can replenish the carrier from the toner cartridge (not illustrated) through a developer replenishing port 64Y1. The developing device 64Y can discharge the developer from a developer discharge port 64Y2 through overflow by an amount to be replenished.

In this way, in the developing device 64Y, an amount of the developer is maintained constant, and an old deteriorated carrier is replaced with a new carrier little by little.

Similar to the developing device 14Y, the developing devices 14M, 14C, and 14K in FIG. 4 may be respectively modified into developing devices 64M, 64C, and 64K (not illustrated) similar to the developing device 64Y except that a magenta toner, a cyan toner, and a black toner are respectively used instead of the yellow toner.

The toner according to at least one embodiment described above is excellent in low-temperature fixability, excellent in storage stability in a high-temperature environment even when recycled, and is capable of sufficiently maintaining the charge amount.

### Examples

Hereinafter, the embodiment will be described in more detail by means of Examples.

Preparations of ester waxes A1 to A12 and B1 to B8 in Examples will be described.

A four-necked flask equipped with a stirrer, a thermocouple, and a nitrogen inlet tube was charged with 80 parts by mass of at least three types of long-chain alkylcarboxylic acids and 20 parts by mass of at least three types of long-chain alkyl alcohols. An esterification reaction was executed at 220° C. under a nitrogen stream to obtain a reaction product. A mixed solvent of toluene and ethanol was added to the obtained reaction product to dissolve the reaction product. Further, a sodium hydroxide aqueous solution was added to the flask, and the mixture was stirred at 70° C. for 30 minutes. Further, the flask was allowed to stand for 30 minutes to separate the content in the flask into an organic layer and an aqueous layer, and the aqueous layer was removed from the content. Thereafter, ion exchange water was added to the flask, and the mixture was stirred at 70° C. for 30 minutes. The flask was allowed to stand for 30 minutes to separate the content in the flask into an aqueous layer and an organic layer, and the aqueous layer was removed from the content. The operation was repeated five times. The solvent was distilled off from the organic layer of the content in the flask under a reduced pressure to obtain an ester wax A1.

Ester waxes A2 to A12 were obtained in the same manner as the ester wax A1 except that types and usage amounts of the long-chain alkylcarboxylic acids and the long-chain alkyl alcohols used were changed. Ester waxes B1 to B8 were obtained by the same operation.

The long-chain alkylcarboxylic acids used are as follows.
Palmitic acid (C₁₆H₃₂O₂)
Stearic acid (C₁₈H₃₆O₂)
Arachidic acid (C₂₀H₄₀O₂)
Behenic acid (C₂₂H₄₄O₂)
Lignoceric acid (C₂₄H₄₈O₂)
Cerotic acid (C₂₆H₅₂O₂)
Montanic acid (C₂₈H₅₆O₂)

The long-chain alkyl alcohols used are as follows.
Palmityl alcohol (C₁₆H₃₄O)
Stearyl alcohol (C₁₈H₃₈O)
Arachidyl alcohol (C₂₀H₄₂O)
Behenyl alcohol (C₂₂H₄₆O)
Lignoceryl alcohol (C₂₄H₅₀O)
Ceryl alcohol (C₂₆H₅₄O)
Montanyl alcohol (C₂₈H₅₈O)

A toner according to Example 1 was produced as follows.

First, raw materials of a toner mother particle were charged into a Henschel mixer (manufactured by Mitsui Mining Co., Ltd.) and mixed. Further, a mixture of the raw materials of the toner mother particle was melted and kneaded by a twin-screw extruder. The melt-kneaded product was cooled and then coarsely pulverized with a hammer mill. The coarsely pulverized product was finely pulverized by a jet pulverizer. The finely pulverized product was classified to obtain the toner mother particle.

The composition of the raw materials of the toner mother particle is shown below.

Crystalline polyester resin: 5 parts by mass

Amorphous polyester resin: 85 parts by mass

Ester wax A1: 5 parts by mass

Carbon black: 4.5 parts by mass

Charge control agent: 0.5 parts by mass

Next, the temperature in the Herschel mixer having a temperature control function is set to 25° C. After the toner mother particle was charged into a stirring unit, 0.5 parts by mass of titanium oxide was charged with respect to 100 parts by mass of the toner mother particle, and the mixture was stirred at 25° C. and 2500 rpm for 6 minutes. Thereafter, the stirring was stopped, 0.45 parts by mass of the silica A with respect to 100 parts by mass of the toner mother particle was added to the stirring unit, and the mixture was stirred at 25° C. and 2500 rpm for 360 seconds. The stirring was stopped again, 0.75 parts by mass of the silica B with respect to 100 parts by mass of the toner mother particle and other necessary external additives were added to the stirring unit, and the mixture was further stirred at 25° C. and 2500 rpm for 360 seconds to obtain the toner according to Example 1.

Toners according to Examples 2 to 23 and Comparative Examples 1 to 22 were produced as follows.

First, toner mother particles of Examples 2 to 23 and Comparative Examples 1 to 22 were produced in the same manner as in Example 1 except that ester waxes A2 to A12 and B1 to B8 were used in place of the ester wax A1 as shown in Tables 1, 2, 3, and 4 with respect to the composition of the raw materials of the toner mother particle.

Next, the external additive was mixed with the toner mother particle in each Example to produce the toners according to Examples 2 to 23 and Comparative Examples 1 to 22 in the same manner as in Example 1 except that an average primary particle diameter D₅₀ (r_{A}) of the silica A, an average primary particle diameter D₅₀ (r_{B}) of the silica B, a content w_{A} of the silica A, and a content w_{B} of the silica B were changed as shown in Tables 1, 2, 3, and 4, and external addition conditions of the silica A and the silica B were changed as shown in Tables 5, 6, 7, and 8.

TABLE 1

| | | | | w_{A} | w_{B} | | Residual | Residual |
|---|---|---|---|---|---|---|---|---|
| | | r_{A} | r_{B} | (part by | (part by | | ratio X | ratio Y |
| | Ester wax | (nm) | (nm) | mass) | mass) | w_{B}/w_{A} | (%) | (%) |
| Example 1 | Ester wax A1 | 12 | 120 | 0.45 | 0.75 | 1.7 | 85.0 | 50.0 |
| Example 2 | Ester wax A2 | 12 | 120 | 0.45 | 0.75 | 1.7 | 85.0 | 50.0 |
| Example 3 | Ester wax A3 | 12 | 120 | 0.45 | 0.75 | 1.7 | 85.0 | 50.0 |
| Example 4 | Ester wax A4 | 12 | 120 | 0.45 | 0.75 | 1.7 | 85.0 | 50.0 |
| Example 5 | Ester wax A5 | 12 | 120 | 0.45 | 0.75 | 1.7 | 85.0 | 50.0 |
| Example 6 | Ester wax A6 | 12 | 120 | 0.45 | 0.75 | 1.7 | 85.0 | 50.0 |
| Example 7 | Ester wax A7 | 12 | 120 | 0.45 | 0.75 | 1.7 | 85.0 | 50.0 |
| Example 8 | Ester wax A8 | 12 | 120 | 0.45 | 0.75 | 1.7 | 85.0 | 50.0 |
| Example 9 | Ester wax A9 | 12 | 120 | 0.45 | 0.75 | 1.7 | 85.0 | 50.0 |
| Example 10 | Ester wax A10 | 12 | 120 | 0.45 | 0.75 | 1.7 | 85.0 | 50.0 |
| Example 11 | Ester wax A11 | 10 | 120 | 0.45 | 0.75 | 1.7 | 85.0 | 50.0 |
| Example 12 | Ester wax A11 | 14 | 120 | 0.45 | 0.75 | 1.7 | 85.0 | 50.0 |

| | Ratio of | Low- | | | | |
|---|---|---|---|---|---|---|
| | residual | temperature | Heat | Conveyance | Toner | Image |
| | ratios X/Y | fixability | resistance | property | scattering | density |
| Example 1 | 1.7 | Good | Good | Good | Good | Good |
| Example 2 | 1.7 | Good | Good | Good | Good | Good |
| Example 3 | 1.7 | Good | Good | Good | Good | Good |
| Example 4 | 1.7 | Good | Good | Good | Good | Good |
| Example 5 | 1.7 | Good | Good | Good | Good | Good |
| Example 6 | 1.7 | Good | Good | Good | Good | Good |
| Example 7 | 1.7 | Good | Good | Good | Good | Good |
| Example 8 | 1.7 | Good | Good | Good | Good | Good |
| Example 9 | 1.7 | Good | Good | Good | Good | Good |
| Example 10 | 1.7 | Good | Good | Good | Good | Good |
| Example 11 | 1.7 | Good | Good | Good | Good | Good |
| Example 12 | 1.7 | Good | Good | Good | Good | Good |

TABLE 2

| | | | | w_{A} | w_{B} | | Residual | Residual |
|---|---|---|---|---|---|---|---|---|
| | | r_{A} | r_{B} | (part by | (part by | | ratio X | ratio Y |
| | Ester wax | (nm) | (nm) | mass) | mass) | w_{B}/w_{A} | (%) | (%) |
| Example 13 | Ester wax A11 | 12 | 90 | 0.45 | 0.75 | 1.7 | 85.0 | 50.0 |
| Example 14 | Ester wax A11 | 12 | 150 | 0.45 | 0.75 | 1.7 | 85.0 | 50.0 |
| Example 15 | Ester wax A11 | 12 | 120 | 0.1 | 0.5 | 5.0 | 85.0 | 50.0 |
| Example 16 | Ester wax A11 | 12 | 120 | 0.8 | 0.8 | 1.0 | 85.0 | 50.0 |
| Example 17 | Ester wax A12 | 12 | 120 | 0.3 | 0.3 | 1.0 | 85.0 | 50.0 |
| Example 18 | Ester wax A12 | 12 | 120 | 0.24 | 1.2 | 5.0 | 85.0 | 50.0 |
| Example 19 | Ester wax A12 | 12 | 120 | 0.45 | 0.75 | 1.7 | 70.0 | 50.0 |
| Example 20 | Ester wax A12 | 12 | 120 | 0.45 | 0.75 | 1.7 | 85.0 | 30.0 |
| Example 21 | Ester wax A12 | 12 | 120 | 0.45 | 0.75 | 1.7 | 70.0 | 70.0 |
| Example 22 | Ester wax A12 | 12 | 120 | 0.45 | 0.75 | 1.7 | 90.0 | 30.0 |
| Example 23 | Ester wax A12 | 12 | 120 | 0.45 | 0.75 | 1.7 | 90.0 | 90.0 |

| | Ratio of | Low- | | | | |
|---|---|---|---|---|---|---|
| | residual | temperature | Heat | Conveyance | Toner | Image |
| | ratios X/Y | fixability | resistance | property | scattering | density |
| Example 13 | 1.7 | Good | Good | Good | Good | Good |
| Example 14 | 1.7 | Good | Good | Good | Good | Good |
| Example 15 | 1.7 | Good | Good | Good | Good | Good |
| Example 16 | 1.7 | Good | Good | Good | Good | Good |
| Example 17 | 1.7 | Good | Good | Good | Good | Good |
| Example 18 | 1.7 | Good | Good | Good | Good | Good |
| Example 19 | 1.4 | Good | Good | Good | Good | Good |
| Example 20 | 2.8 | Good | Good | Good | Good | Good |
| Example 21 | 1.0 | Good | Good | Good | Good | Good |
| Example 22 | 3.0 | Good | Good | Good | Good | Good |
| Example 23 | 1.0 | Good | Good | Good | Good | Good |

TABLE 3

| | | | | wA | wB | | Residual | Residual |
|---|---|---|---|---|---|---|---|---|
| | | rA | rB | (part by | (part by | | ratio X | ratio Y |
| | Ester wax | (nm) | (nm) | mass) | mass) | wB/wA | (%) | (%) |
| Comparative | Ester wax B1 | 12 | 120 | 0.45 | 0.75 | 1.7 | 85.0 | 50.0 |
| Example 1 | | | | | | | | |
| Comparative | Ester wax B2 | 12 | 120 | 0.45 | 0.75 | 1.7 | 85.0 | 50.0 |
| Example 2 | | | | | | | | |
| Comparative | Ester wax B3 | 12 | 120 | 0.45 | 0.75 | 1.7 | 85.0 | 50.0 |
| Example 3 | | | | | | | | |
| Comparative | Ester wax B4 | 12 | 120 | 0.45 | 0.75 | 1.7 | 85.0 | 50.0 |
| Example 4 | | | | | | | | |
| Comparative | Ester wax B5 | 12 | 120 | 0.45 | 0.75 | 1.7 | 85.0 | 50.0 |
| Example 5 | | | | | | | | |
| Comparative | Ester wax B6 | 12 | 120 | 0.45 | 0.75 | 1.7 | 85.0 | 50.0 |
| Example 6 | | | | | | | | |
| Comparative | Ester wax B7 | 12 | 120 | 0.45 | 0.75 | 1.7 | 85.0 | 50.0 |
| Example 7 | | | | | | | | |
| Comparative | Ester wax B8 | 12 | 120 | 0.45 | 0.75 | 1.7 | 85.0 | 50.0 |
| Example 8 | | | | | | | | |
| Comparative | Ester wax A12 | 9 | 120 | 0.45 | 0.75 | 1.7 | 85.0 | 50.0 |
| Example 9 | | | | | | | | |
| Comparative | Ester wax A12 | 15 | 120 | 0.45 | 0.75 | 1.7 | 85.0 | 50.0 |
| Example 10 | | | | | | | | |
| Comparative | Ester wax A12 | 12 | 89 | 0.45 | 0.75 | 1.7 | 85.0 | 50.0 |
| Example 11 | | | | | | | | |

| | Ratio of | Low- | | | | |
|---|---|---|---|---|---|---|
| | residual | temperature | Heat | Conveyance | Toner | Image |
| | ratios X/Y | fixability | resistance | property | scattering | density |
| Comparative | 1.7 | Poor | Good | Good | Good | Good |
| Example 1 | | | | | | |
| Comparative | 1.7 | Poor | Good | Good | Good | Good |
| Example 2 | | | | | | |
| Comparative | 1.7 | Good | Poor | Good | Good | Good |
| Example 3 | | | | | | |
| Comparative | 1.7 | Good | Poor | Good | Good | Good |
| Example 4 | | | | | | |
| Comparative | 1.7 | Good | Good | Poor | Good | Good |
| Example 5 | | | | | | |
| Comparative | 1.7 | Poor | Good | Good | Good | Good |
| Example 6 | | | | | | |
| Comparative | 1.7 | Good | Good | Poor | Good | Good |
| Example 7 | | | | | | |
| Comparative | 1.7 | Poor | Good | Good | Good | Good |
| Example 8 | | | | | | |
| Comparative | 1.7 | Good | Good | Good | Poor | Good |
| Example 9 | | | | | | |
| Comparative | 1.7 | Good | Good | Good | Poor | Good |
| Example 10 | | | | | | |
| Comparative | 1.7 | Good | Poor | Poor | Good | Good |
| Example 11 | | | | | | |

TABLE 4

| | | | | w_{A} | w_{B} | | Residual | Residual |
|---|---|---|---|---|---|---|---|---|
| | | r_{A} | r_{B} | (part by | (part by | | ratio X | ratio Y |
| | Ester wax | (nm) | (nm) | mass) | mass) | w_{B}/w_{A} | (%) | (%) |
| Comparative | Ester wax A12 | 12 | 151 | 0.45 | 0.75 | 1.7 | 85.0 | 50.0 |
| Example 12 | | | | | | | | |
| Comparative | Ester wax A12 | 12 | 120 | 0.05 | 0.75 | 15.0 | 85.0 | 50.0 |
| Example 13 | | | | | | | | |
| Comparative | Ester wax A12 | 12 | 120 | 0.9 | 0.75 | 0.8 | 85.0 | 50.0 |
| Example 14 | | | | | | | | |
| Comparative | Ester wax A12 | 12 | 120 | 0.45 | 0.2 | 0.4 | 85.0 | 50.0 |
| Example 15 | | | | | | | | |
| Comparative | Ester wax A12 | 12 | 120 | 0.45 | 1.3 | 2.9 | 85.0 | 50.0 |
| Example 16 | | | | | | | | |
| Comparative | Ester wax A12 | 12 | 120 | 0.8 | 0.75 | 0.9 | 85.0 | 50.0 |
| Example 17 | | | | | | | | |
| Comparative | Ester wax A12 | 12 | 120 | 0.23 | 1.2 | 5.2 | 85.0 | 50.0 |
| Example 18 | | | | | | | | |
| Comparative | Ester wax A12 | 12 | 120 | 0.45 | 0.75 | 1.7 | 69.0 | 50.0 |
| Example 19 | | | | | | | | |
| Comparative | Ester wax A12 | 12 | 120 | 0.45 | 0.75 | 1.7 | 85.0 | 29.0 |
| Example 20 | | | | | | | | |
| Comparative | Ester wax A12 | 12 | 120 | 0.45 | 0.75 | 1.7 | 70.0 | 75.0 |
| Example 21 | | | | | | | | |
| Comparative | Ester wax A12 | 12 | 120 | 0.45 | 0.75 | 1.7 | 95.0 | 30.0 |
| Example 22 | | | | | | | | |

| | Ratio of | Low- | | | | |
|---|---|---|---|---|---|---|
| | residual | temperature | Heat | Conveyance | Toner | Image |
| | ratios X/Y | fixability | resistance | property | scattering | density |
| Comparative | 1.7 | Good | Good | Good | Poor | Good |
| Example 12 | | | | | | |
| Comparative | 1.7 | Good | Good | Poor | Poor | Good |
| Example 13 | | | | | | |
| Comparative | 1.7 | Good | Good | Good | Good | Poor |
| Example 14 | | | | | | |
| Comparative | 1.7 | Good | Poor | Poor | Good | Good |
| Example 15 | | | | | | |
| Comparative | 1.7 | Good | Good | Good | Poor | Good |
| Example 16 | | | | | | |
| Comparative | 1.7 | Good | Good | Good | Good | Poor |
| Example 17 | | | | | | |
| Comparative | 1.7 | Good | Good | Good | Poor | Good |
| Example 18 | | | | | | |
| Comparative | 1.4 | Good | Good | Good | Poor | Good |
| Example 19 | | | | | | |
| Comparative | 2.9 | Good | Good | Poor | Good | Good |
| Example 20 | | | | | | |
| Comparative | 0.9 | Good | Good | Good | Poor | Good |
| Example 21 | | | | | | |
| Comparative | 3.2 | Good | Good | Good | Good | Poor |
| Example 22 | | | | | | |

TABLE 5

| | Addition of silica A | | | Addition of silica B | | |
|---|---|---|---|---|---|---|
| | (first step) | | | (second step) | | |
| | Rotation | Stirring | | Rotation | Stirring | |
| | speed | time | Temperature | speed | time | Temperature |
| | (rpm) | (s) | (° C.) | (rpm) | (s) | (° C.) |
| Example 1 | 2500 | 360 | 25 | 2500 | 360 | 25 |
| Example 2 | 2500 | 360 | 25 | 2500 | 360 | 25 |
| Example 3 | 2500 | 360 | 25 | 2500 | 360 | 25 |
| Example 4 | 2500 | 360 | 25 | 2500 | 360 | 25 |
| Example 5 | 2500 | 300 | 25 | 2500 | 360 | 25 |
| Example 6 | 2500 | 300 | 25 | 2500 | 360 | 25 |
| Example 7 | 2500 | 300 | 25 | 2500 | 360 | 25 |
| Example 8 | 2500 | 300 | 25 | 2500 | 360 | 25 |
| Example 9 | 2500 | 300 | 25 | 2500 | 360 | 25 |
| Example 10 | 2500 | 300 | 25 | 2500 | 360 | 25 |
| Example 11 | 2500 | 300 | 25 | 2500 | 360 | 25 |
| Example 12 | 2500 | 300 | 25 | 2500 | 360 | 25 |

TABLE 6

| | Addition of silica A | | | Addition of silica B | | |
|---|---|---|---|---|---|---|
| | (first step) | | | (second step) | | |
| | Rotation | Stirring | | Rotation | Stirring | |
| | speed | time | Temperature | speed | time | Temperature |
| | (rpm) | (s) | (° C.) | (rpm) | (s) | (° C.) |
| Example 13 | 2500 | 300 | 25 | 2500 | 360 | 25 |
| Example 14 | 2500 | 300 | 25 | 2500 | 360 | 25 |
| Example 15 | 2500 | 300 | 25 | 2500 | 360 | 25 |
| Example 16 | 2500 | 300 | 25 | 2500 | 360 | 25 |
| Example 17 | 2500 | 300 | 25 | 2500 | 360 | 25 |
| Example 18 | 2500 | 300 | 25 | 2500 | 360 | 25 |
| Example 19 | 2000 | 300 | 25 | 2500 | 360 | 25 |
| Example 20 | 2500 | 300 | 25 | 2000 | 300 | 25 |
| Example 21 | 2000 | 300 | 25 | 2500 | 300 | 25 |
| Example 22 | 3000 | 300 | 25 | 2000 | 300 | 25 |
| Example 23 | 3000 | 300 | 25 | 3000 | 300 | 25 |

TABLE 7

| | Addition of silica A | | | Addition of silica B | | |
|---|---|---|---|---|---|---|
| | (first step) | | | (second step) | | |
| | Rotation | Stirring | | Rotation | Stirring | |
| | speed | time | Temperature | speed | time | Temperature |
| | (rpm) | (s) | (° C.) | (rpm) | (s) | (° C.) |
| Comparative | 2500 | 300 | 25 | 2500 | 360 | 25 |
| Example 1 | | | | | | |
| Comparative | 2500 | 300 | 25 | 2500 | 360 | 25 |
| Example 2 | | | | | | |
| Comparative | 2500 | 300 | 25 | 2500 | 360 | 25 |
| Example 3 | | | | | | |
| Comparative | 2500 | 300 | 25 | 2500 | 360 | 25 |
| Example 4 | | | | | | |
| Comparative | 2500 | 300 | 25 | 2500 | 360 | 25 |
| Example 5 | | | | | | |
| Comparative | 2500 | 300 | 25 | 2500 | 360 | 25 |
| Example 6 | | | | | | |
| Comparative | 2500 | 300 | 25 | 2500 | 360 | 25 |
| Example 7 | | | | | | |
| Comparative | 2500 | 300 | 25 | 2500 | 360 | 25 |
| Example 8 | | | | | | |
| Comparative | 2500 | 300 | 25 | 2500 | 360 | 25 |
| Example 9 | | | | | | |
| Comparative | 2500 | 300 | 25 | 2500 | 360 | 25 |
| Example 10 | | | | | | |
| Comparative | 2500 | 300 | 25 | 2500 | 360 | 25 |
| Example 11 | | | | | | |

TABLE 8

| | Addition of silica A | | | Addition of silica B | | |
|---|---|---|---|---|---|---|
| | (first step) | | | (second step) | | |
| | Rotation | Stirring | | Rotation | Stirring | |
| | speed | time | Temperature | speed | time | Temperature |
| | (rpm) | (s) | (° C.) | (rpm) | (s) | (° C.) |
| Comparative | 2500 | 300 | 25 | 2500 | 360 | 25 |
| Example 12 | | | | | | |
| Comparative | 2500 | 300 | 25 | 2500 | 360 | 25 |
| Example 13 | | | | | | |
| Comparative | 2500 | 300 | 25 | 2500 | 360 | 25 |
| Example 14 | | | | | | |
| Comparative | 2500 | 300 | 25 | 2500 | 360 | 25 |
| Example 15 | | | | | | |
| Comparative | 2500 | 300 | 25 | 2500 | 360 | 25 |
| Example 16 | | | | | | |
| Comparative | 2500 | 300 | 25 | 2500 | 360 | 25 |
| Example 17 | | | | | | |
| Comparative | 2500 | 300 | 25 | 2500 | 360 | 25 |
| Example 18 | | | | | | |
| Comparative | 2000 | 240 | 25 | 2500 | 360 | 25 |
| Example 19 | | | | | | |
| Comparative | 2500 | 300 | 25 | 2000 | 240 | 25 |
| Example 20 | | | | | | |
| Comparative | 2000 | 180 | 25 | 2500 | 480 | 25 |
| Example 21 | | | | | | |
| Comparative | 3000 | 480 | 25 | 2000 | 300 | 25 |
| Example 22 | | | | | | |

A method of measuring the residual ratio X and the residual ratio Y will be described.

The residual ratio X and the residual ratio Y were calculated according to the following equations.

Residual Ratio X=(Nₐ₂/Nₐ₁)×100 Equation (1)

Residual Ratio Y=(N_{b2}/N_{b1})×100 Equation (2)

In the equation (1), Nₐ₁ is the number of adhered silica A measured for the toner according to each Example, and Nₐ₂ is the number of adhered silica A measured for a particle z obtained by the following method Z.

In the equation (2), N_{b1} is the number of adhered silica B measured for the toner according to each Example, and N_{b2} is the number of adhered silica B measured for the particle z obtained by the following method Z.

Nₐ₁, Nₐ₂, N_{b1}, and N_{b2} represent the number of each adhered silica in the scanning electron microscope (SEM) image. Specifically, the number was observed by an SEM (“ULTRA 55” manufactured by ZEISS) at a magnification of 50,000 times. A frame of 1 μm×1 μm (1 μm²) was provided on the field of view, and the number of silica particles present in this frame was measured for each of various types of silica.

Method Z: 11 g of the toner according to each Example, 56.8 g of ion exchange water, and 12.8 g of a surfactant were added to a 100 ml beaker and were mixed, and the mixture was stirred using a magnetic stirrer until a toner layer on a liquid surface disappeared, thereby preparing a dispersion liquid. This is a dispersing step for the toner. As the surfactant, a “Yashinomi Detergent” manufactured by SALAYA was used.

Next, the dispersion liquid was subjected to an ultrasonic treatment using an ultrasonic cleaner (ASONE US-1R) at 20° C. and 1000 Hz for 10 minutes. This is an impact step for the toner.

After the impact step, the dispersion liquid was poured into two centrifugal tubes, and ion exchange water was added to each centrifugal tube such that the liquid was 45 ml. The centrifugal tube was centrifuged at 20° C. and 1000 rpm for 15 minutes. As a centrifugal separator, a “HSIANG TAI-CN-2060” manufactured by ASONE Corporation was used. Thereafter, a supernatant in the centrifugal tube was removed by decantation, and ion exchange water was added such that the liquid was 45 ml, followed by stirring again. These operations were further executed twice. Thereafter, the detached external additive was separated, and filtration and washing were executed by adding 100 ml of ion exchange water. For the filtration, ADVANTEC GC90 paper was used. After the washing, vacuum drying was executed at 30° C. for 8 hours to obtain the particle z.

The crystalline polyester resin and the amorphous polyester resin used in Examples are as follows.
Crystalline polyester resin (mass average molecular weight: 9.5×10³, melting point: 100° C.)
Amorphous polyester resin (mass average molecular weight: 20×10³, melting temperature: 110° C.)

A method of measuring the melting point of the crystalline polyester resin will be described.

The crystalline polyester resin was measured by a DSC “DSC Q2000 (manufactured by TA Instruments)”. Measurement conditions are as follows.

Amount of sample: 5 mg.

Lid and pan: alumina.

Temperature raising rate: 10° C./min.

Measuring method: the temperature of the sample was raised from 20° C. to 200° C. Thereafter, the sample was cooled to 20° C. or lower. The sample was heated again, and a maximum endothermic peak temperature measured in a temperature range of about 75° C. to 120° C. was defined as the melting point of the crystalline polyester resin.

A method of measuring the melting temperature of the amorphous polyester resin will be described.

The toner according to each Example was molded into a pellet shape by applying a pressure with a pressure applying machine. For the pellet, the melting temperature of the amorphous polyester resin was measured using a flow tester “CFT-500D, manufactured by Shimadzu Corporation” under the following conditions.

Measurement start temperature: 30° C.

Measurement end temperature: 200° C.

Load: 10 kgf

Temperature raising rate: 10° C./min

In the flow tester, a temperature corresponding to a midpoint (½) between an outflow start temperature at which a melt outflow started and an outflow end temperature at which the entire sample was melted and flowed out was defined as the melting temperature.

A method of measuring a carbon atom distribution (a ratio of the ester compound having each number of carbon atoms) of the ester compound constituting the ester wax will be described.

0.5 g of the toner according to each Example was weighed and accommodated in an Erlenmeyer flask. Next, 2 mL of methylene chloride was added to the Erlenmeyer flask to dissolve the toner. Further, 4 ml of hexane was added to the Erlenmeyer flask to prepare a mixed liquid. The mixed liquid was filtered and separated into a filtrate and an insoluble matter. The solvent was distilled off from the filtrate under a nitrogen stream to obtain a precipitate. For the precipitate, the carbon atom distribution of the ester compound in the ester wax extracted from the toner was measured.

The ratio of the ester compound having each number of carbon atoms was measured by FD-MS “JMS-T100GC” (manufactured by JEOL Ltd.). Measurement conditions are as follows.

Concentration of sample: 1 mg/ml (solvent: chloroform).

Cathode voltage: −10 kv.

Spectrum recording interval: 0.4 s.

Measurement mass range (m/z): 10 to 2000.

A total ion strength of the ester compound having each number of carbon atoms obtained by the measurement was defined as 100. A relative value of the ion strength of the ester compound having each number of carbon atoms with respect to the total ion strength was determined. The relative value was defined as the ratio of the ester compound having each number of carbon atoms in the ester wax. The number of carbon atoms in the ester compound having the maximum relative value was represented by C₁.

A method of analyzing the first monomer group and the second monomer group will be described.

1 g of each ester wax was subjected to a methanolysis reaction at a temperature of 70° C. for 3 hours. A product after the methanolysis reaction was subjected to mass spectrometry by FD-MS to determine a content of the long-chain alkylcarboxylic acid having each number of carbon atoms and a content of the long-chain alkyl alcohol having each number of carbon atoms.

A method of measuring a carbon atom distribution (a ratio of the carboxylic acid having each number of carbon atoms) of the carboxylic acid constituting the first monomer group will be described.

The ratio of the carboxylic acid having each number of carbon atoms was measured by FD-MS “JMS-T100GC” (manufactured by JEOL Ltd.). Measurement conditions are as follows.

Concentration of sample: 1 mg/ml (solvent: chloroform).

Cathode voltage: −10 kv.

Spectrum recording interval: 0.4 s.

Measurement mass range (m/z): 10 to 2000.

A total ion strength of the carboxylic acid having each number of carbon atoms obtained by the measurement was defined as 100. A relative value of the ion strength of the carboxylic acid having each number of carbon atoms with respect to the total ion strength was determined. The relative value was defined as the ratio of the carboxylic acid having each number of carbon atoms in the ester wax. The number of carbon atoms in the carboxylic acid having the maximum relative value was represented by Cₙ.

A method of measuring a carbon atom distribution (a ratio of the alcohol having each number of carbon atoms) of the alcohol constituting the second monomer group will be described.

The ratio of the alcohol having each number of carbon atoms was measured by FD-MS “JMS-T100GC” (manufactured by JEOL Ltd.). Measurement conditions are as follows.

Concentration of sample: 1 mg/ml (solvent: chloroform).

Cathode voltage: −10 kv.

Spectrum recording interval: 0.4 s.

Measurement mass range (m/z): 10 to 2000.

A total ion strength of the alcohol having each number of carbon atoms obtained by the measurement was defined as 100. A relative value of the ion strength of the alcohol having each number of carbon atoms with respect to the total ion strength was determined. The relative value was defined as the ratio of the alcohol having each number of carbon atoms in the ester wax. The number of carbon atoms in the alcohol having the maximum relative value was represented by Cₙ.

The ester waxes A1 to A12 and B1 to B8 used in Examples will be described.

In all of the ester waxes A1 to A12, the number of carbon atoms C₁ of the ester compound having the maximum content was 44, the number of carbon atoms Cₙ of the carboxylic acid having the maximum content in the first monomer group was 22, and the number of carbon atoms Cₘ of the alcohol having the maximum content in the second monomer group was 20.

For the ester waxes A1 to A12, the carbon number distribution of the ester wax had only one maximum peak in a region having 43 or more carbon atoms.

Properties of the ester waxes A1 to A12 obtained based on measurement results of mass distribution are shown in Table 9. Properties of the ester waxes B1 to B8 are shown in Table 10.

TABLE 9

| | a1 | a2 | b1 | b2 | c1 | c2 |
|---|---|---|---|---|---|---|
| Ester wax A1 | 4 | 4 | 3 | 15 | 82.5 | 80 |
| Ester wax A2 | 4 | 4 | 0 | 15 | 82.5 | 80 |
| Ester wax A3 | 4 | 4 | 5 | 15 | 82.5 | 80 |
| Ester wax A4 | 4 | 4 | 3 | 0 | 82.5 | 80 |
| Ester wax A5 | 4 | 4 | 3 | 20 | 82.5 | 80 |
| Ester wax A6 | 3 | 3 | 3 | 15 | 82.5 | 80 |
| Ester wax A7 | 4 | 3 | 3 | 15 | 70 | 80 |
| Ester wax A8 | 4 | 3 | 3 | 15 | 95 | 80 |
| Ester wax A9 | 4 | 3 | 3 | 15 | 82.5 | 70 |
| Ester wax A10 | 4 | 3 | 3 | 15 | 82.5 | 90 |
| Ester wax A11 | 4 | 3 | 3 | 15 | 82.5 | 80 |
| Ester wax A12 | 4 | 4 | 3 | 15 | 82.5 | 80 |

TABLE 10

| | a1 | a2 | b1 | b2 | c1 | c2 |
|---|---|---|---|---|---|---|
| Ester wax B1 | 4 | 4 | 6 | 15 | 82.5 | 80 |
| Ester wax B2 | 4 | 4 | 3 | 21 | 82.5 | 80 |
| Ester wax B3 | 2 | 3 | 3 | 15 | 82.5 | 80 |
| Ester wax B4 | 3 | 2 | 3 | 15 | 82.5 | 80 |
| Ester wax B5 | 4 | 4 | 3 | 15 | 69 | 80 |
| Ester wax B6 | 4 | 4 | 3 | 15 | 96 | 80 |
| Ester wax B7 | 4 | 4 | 3 | 15 | 82.5 | 69 |
| Ester wax B8 | 4 | 4 | 3 | 15 | 82.5 | 91 |

In Tables 9 and 10, a₁ is the number of types of carboxylic acids in the first monomer group. a₂ is the number of types of alcohols in the second monomer group. b₁ is a total ratio [% by mass] of the carboxylic acid having 18 or less carbon atoms with respect to 100% by mass of the first monomer group. b₂ is a total ratio [% by mass] of the alcohol having 18 or less carbon atoms with respect to 100% by mass of the second monomer group. c₁ is a ratio [% by mass] of the carboxylic acid having Cₙ carbon atoms with respect to 100% by mass of the first monomer group. c₂ is a ratio [% by mass] of the alcohol having Cₘ carbon atoms with respect to 100% by mass of the second monomer group.

A method of measuring the average primary particle diameters D₅₀ of the silica A and the silica B will be described.

A laser diffraction particle size distribution measuring device (manufactured by Shimadzu Corporation (SALD7000)) was used.

The developer according to Examples will be described.

8.5 parts by mass of the toner according to each Example was stirred with respect to 100 parts by mass of a ferrite carrier by a turbo mixer to obtain the developer according to each Example. A surface of the ferrite carrier is coated with a silicone resin having an average particle diameter of 40 μm.

A method of evaluating the low-temperature fixability will be described.

The developer according to each Example was accommodated in a toner cartridge. The toner cartridge was disposed in an image forming apparatus for evaluating the low-temperature fixability. The image forming apparatus for evaluating the low-temperature fixability is obtained by modifying a commercially available e-studio 5018A (manufactured by TOSHIBA TEC CORPORATION) such that a fixing temperature can be changed from 100° C. to 200° C. in an increment of 0.1° C. The image forming apparatus for evaluating the low-temperature fixability was used, the fixing temperature was set to 150° C., and ten solid images having a toner adhered amount of 1.5 mg/cm² were obtained. When no image peeling due to offset and unfixed state occurred in all of the ten solid images, the set temperature was lowered by 1° C., and a solid image was obtained in the same manner as described above. The operation was repeated to determine a lower limit temperature of the fixing temperature at which no image peeling occurred in the solid image, and the lower limit temperature was defined as a minimum fixing temperature of the toner. When the minimum fixing temperature was 120° C. or lower, the low-temperature fixability of the toner was evaluated as acceptable (good). When the minimum fixing temperature was higher than 120° C., the low-temperature fixability of the toner was evaluated as unacceptable (poor).

A method of evaluating the storage stability in a high-temperature environment will be described.

When evaluation results of the following four items of “heat resistance”, “conveyance property”, “toner scattering”, and “image density” were all acceptable (good), the storage stability in a high-temperature environment was evaluated to be excellent.

A method of evaluating the “heat resistance” will be described.

The toner according to each Example was allowed to stand at 55° C. for 10 hours. After allowing the toner to stand at 55° C. for 10 hours, 15 g of the toner was sieved with a mesh having an opening of 0.07 mm, and the toner remaining on the mesh was weighed. The smaller the amount of the toner remaining on the mesh, the less the aggregation and the better the heat resistance. When the amount of the toner remaining on the mesh was 3 g or less, the heat resistance of the toner was evaluated as acceptable (good). When the amount of the toner remaining on the mesh was more than 3 g, the heat resistance of the toner was evaluated as unacceptable (poor).

A method of evaluating the “conveyance property” will be described.

A commercially available e-studio 5018A (manufactured by TOSHIBA TEC CORPORATION) was used, and a temperature of a developing unit Dc-Sl was adjusted to be saturated at 47° C. Then, while the recycling system was operated, 30,000 sheets of A4-size images with a printing ratio of 8% were printed on both sides under a high-temperature and high-humidity environment, and the temperature of the developing unit Dc-Sl was adjusted to be maintained at 47° C. by adjusting an air volume of a cooling fan. An image density difference after printing the 30,000 sheets of images was measured with a densitometer (“eXact” manufactured by X-Rite Co., Ltd.). The image density of the solid image was measured by a densitometer every 1 cm in a main scanning direction, and a difference between a maximum value and a minimum value of all these values was obtained.

When the image density difference was less than 0.8, the conveyance property of the developer was evaluated as acceptable (good). When the image density difference was 0.8 or more, the conveyance property of the developer was evaluated as unacceptable (poor).

A method of evaluating the “toner scattering” will be described.

A commercially available e-studio 5018A (manufactured by TOSHIBA TEC CORPORATION) was used, and a document having a printing ratio of 8.0% was continuously copied on 200,000 sheets of A4 paper. Thereafter, the toner deposited on a lower side of a magnet roller of the developing unit was sucked by a vacuum cleaner, and an amount of the deposited toner was measured as an amount of scattered toner. When the amount of scattered toner was 170 mg or less, the charge amount of the toner was evaluated as acceptable (good). When the amount of scattered toner was more than 170 mg, the charge amount of the toner was evaluated as unacceptable (poor).

A method of evaluating the “image density” will be described.

The developer according to each Example was allowed to stand in a thermostatic chamber at a temperature of 10° C. and a humidity of 20% for 24 hours, and then accommodated in a toner cartridge. The toner cartridge was disposed in a commercially available e-studio 5018A (manufactured by TOSHIBA TEC CORPORATION). After 100 sheets of charts having a printing ratio of 10% were printed, a solid image of A4 size was printed, and image densities at four corners and the center of the image were measured with a densitometer (“eXact” manufactured by X-Rite Co., Ltd.), and an average value of these five positions was obtained. When the average value of the image densities was 1.0 or more, the image density was evaluated as acceptable (good). When the average value of the image densities was less than 1.0, the image density was evaluated as unacceptable (poor).

Evaluation results of the low-temperature fixability, the heat resistance, the conveyance property, the toner scattering, and the image density of the toner according to each Example are shown in Tables 1, 2, 3, and 4.

The toners according to Examples 1 to 23 have excellent low-temperature fixability and excellent storage stability in a high-temperature environment. The e-studio 5018A is an image forming apparatus that recycles the toner. Therefore, the toners according to Examples 1 to 23 are excellent in storage stability in a high-temperature environment even when recycled, and is capable of sufficiently maintaining the charge amount.

In contrast, the toners according to Comparative Examples 1 to 22 did not reach acceptance criteria at the same time in all of the low-temperature fixability, the heat resistance, the conveyance property, the toner scattering, and the image density.

With respect to any figure or numerical range for a given characteristic, a figure or a parameter from one range may be combined with another figure or a parameter from a different range for the same characteristic to generate a numerical range.

Other than in the operating examples, if any, or where otherwise indicated, all numbers, values and/or expressions referring to parameters, measurements, conditions, etc., used in the specification and claims are to be understood as modified in all instances by the term “about.”

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A toner, comprising:
a toner mother particle; and
an external additive adhered to a surface of the toner mother particle, wherein
the toner mother particle comprises a crystalline polyester resin, an ester wax, and a colorant,
the external additive comprises silica A having an average primary particle diameter D₅₀ of 10 nm to 14 nm and monodispersed silica B having an average primary particle diameter D₅₀ of 90 nm to 150 nm,
the ester wax comprises a condensation polymer of a first monomer group including at least three types of carboxylic acids and a second monomer group including at least three types of alcohols,
a ratio of a carboxylic acid having 18 or less carbon atoms in the first monomer group is 5% by mass or less with respect to 100% by mass of the first monomer group,
a ratio of an alcohol having 18 or less carbon atoms in the second monomer group is 20% by mass or less with respect to 100% by mass of the second monomer group,
a ratio of a carboxylic acid having Cₙ carbon atoms, which is a maximum content in the first monomer group, is 70% by mass to 95% by mass with respect to 100% by mass of the first monomer group,
a ratio of an alcohol having Cₘ carbon atoms, which is a maximum content in the second monomer group, is 70% by mass to 90% by mass with respect to 100% by mass of the second monomer group,
a content of the silica A is 0.1 parts by mass to 0.8 parts by mass with respect to 100 parts by mass of the toner mother particle,
a content of the silica B is 0.3 parts by mass to 1.2 parts by mass with respect to 100 parts by mass of the toner mother particle,
a ratio of the content of the silica B to the content of the silica A is 1.0 to 5.0,
a residual ratio X of the silica A calculated according to the following equation (1) is 70% or more,
a residual ratio Y of the silica B calculated according to the following equation (2) is 30% or more, and
a ratio of the residual ratio X to the residual ratio Y is 1.0 to 3.0,
Residual Ratio X=(Nₐ₂/Nₐ₁)×100 Equation (1)
Residual Ratio Y=(N_{b2}/N_{b1})×100 Equation (2)
in the equation (1), Nₐ₁ is a number of adhered silica A measured for the toner, and Nₐ₂ is a number of adhered silica A measured for a particle z obtained by a following method Z, and
in the equation (2), N_{b1} is a number of adhered silica B measured for the toner, and N_{b2} is a number of adhered silica B measured for the particle z obtained by the following method Z,
Method Z: executing an ultrasonic treatment on an aqueous liquid containing the toner, water, and a surfactant at 20° C. and 1000 Hz for 10 minutes, then centrifuging the obtained aqueous liquid at 20° C. and 1000 rpm for 15 minutes, removing the separated external additive, and then executing drying to obtain the number of adhered silica for particle z.

2. The toner according to claim 1, wherein the toner mother particle further comprises an amorphous polyester resin.

3. The toner according to claim 1, wherein a total of the content of the silica A and the content of the silica B is 0.5 parts by mass to 1.7 parts by mass with respect to 100 parts by mass of the toner mother particle.

4. A toner cartridge comprising the toner according to claim 1.

5. An image forming apparatus comprising the toner according to claim 1.

6. The toner according to claim 1, wherein the alcohol comprises one or more of: ethylene glycol, 1,2-propylene glycol, 1,3-propylene glycol, 1,4-butanediol, 1,5-pentanediol, 1,6-hexanediol, neopentyl glycol, 1,4-butenediol, polyoxypropylene, polyoxyethylene, glycerin, pentaerythritol, and trimethylolpropane.

7. The toner according to claim 1, wherein the carboxylic acid comprises one or more of: adipic acid, oxalic acid, malonic acid, maleic acid, fumaric acid, citraconic acid, itaconic acid, glutaconic acid, succinic acid, phthalic acid, isophthalic acid, terephthalic acid, sebacic acid, azelaic acid, succinic acid substituted with an alkyl group or an alkenyl group, cyclohexanedicarboxylic acid, trimellitic acid, and pyromellitic acid; acid anhydrides thereof; and esters thereof.

8. The toner according to claim 1, wherein the melting point of the crystalline polyester resin is from 60° C. to 120° C.

9. A method of making toner comprising a toner mother particle and an external additive adhered to a surface of the toner mother particle, comprising:
combining a toner mother particle and an external additive so that external additive adheres to a surface of the toner mother particle, wherein
the toner mother particle comprises a crystalline polyester resin, an ester wax, and a colorant,
the external additive comprises silica A having an average primary particle diameter D₅₀ of 10 nm to 14 nm and monodispersed silica B having an average primary particle diameter D₅₀ of 90 nm to 150 nm,
the ester wax comprises a condensation polymer of a first monomer group including at least three types of carboxylic acids and a second monomer group including at least three types of alcohols,
a ratio of a carboxylic acid having 18 or less carbon atoms in the first monomer group is 5% by mass or less with respect to 100% by mass of the first monomer group,
a ratio of an alcohol having 18 or less carbon atoms in the second monomer group is 20% by mass or less with respect to 100% by mass of the second monomer group,
a ratio of a carboxylic acid having Cₙ carbon atoms, which is a maximum content in the first monomer group, is 70% by mass to 95% by mass with respect to 100% by mass of the first monomer group,
a ratio of an alcohol having Cₙ carbon atoms, which is a maximum content in the second monomer group, is 70% by mass to 90% by mass with respect to 100% by mass of the second monomer group,
a content of the silica A is 0.1 parts by mass to 0.8 parts by mass with respect to 100 parts by mass of the toner mother particle,
a content of the silica B is 0.3 parts by mass to 1.2 parts by mass with respect to 100 parts by mass of the toner mother particle,
a ratio of the content of the silica B to the content of the silica A is 1.0 to 5.0,
a residual ratio X of the silica A calculated according to the following equation (1) is 70% or more,
a residual ratio Y of the silica B calculated according to the following equation (2) is 30% or more, and
a ratio of the residual ratio X to the residual ratio Y is 1.0 to 3.0,
Residual Ratio X=(Nₐ₂/Nₐ₁)×100 Equation (1)
Residual Ratio Y=(N_{b2}/N_{b1})×100 Equation (2)
in the equation (1), Nₐ₁ is a number of adhered silica A measured for the toner, and Nₐ₂ is a number of adhered silica A measured for a particle z obtained by a following method Z, and
in the equation (2), N_{b1} is a number of adhered silica B measured for the toner, and N_{b2} is a number of adhered silica B measured for the particle z obtained by the following method Z,
Method Z: executing an ultrasonic treatment on an aqueous liquid containing the toner, water, and a surfactant at 20° C. and 1000 Hz for 10 minutes, then centrifuging the obtained aqueous liquid at 20° C. and 1000 rpm for 15 minutes, removing the separated external additive, and then executing drying to obtain the number of adhered silica for particle z.

10. The method according to claim 9, wherein the toner mother particle further comprises an amorphous polyester resin.

11. The method according to claim 9, wherein a total of the content of the silica A and the content of the silica B is 0.5 parts by mass to 1.7 parts by mass with respect to 100 parts by mass of the toner mother particle.

12. A toner cartridge comprising the toner made according to claim 9.

13. An image forming apparatus comprising the toner made according to claim 9.

14. The method according to claim 9, wherein the alcohol comprises one or more of: ethylene glycol, 1,2-propylene glycol, 1,3-propylene glycol, 1,4-butanediol, 1,5-pentanediol, 1,6-hexanediol, neopentyl glycol, 1,4-butenediol, polyoxypropylene, polyoxyethylene, glycerin, pentaerythritol, and trimethylolpropane.

15. The method according to claim 9, wherein the carboxylic acid comprises one or more of: adipic acid, oxalic acid, malonic acid, maleic acid, fumaric acid, citraconic acid, itaconic acid, glutaconic acid, succinic acid, phthalic acid, isophthalic acid, terephthalic acid, sebacic acid, azelaic acid, succinic acid substituted with an alkyl group or an alkenyl group, cyclohexanedicarboxylic acid, trimellitic acid, and pyromellitic acid; acid anhydrides thereof; and esters thereof.

16. The method according to claim 9, wherein the melting point of the crystalline polyester resin is from 60° C. to 120° C.
